(19) United States
(12) Patent Application Publication
(10) Pub. No.: US 2007/0238509 A1
(43) Pub. Date: Oct. 11, 2007

(54) Gaming machine

(75) Inventor: Takaaki Hishinuma, Koto-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/393,733

(22) Filed: Mar. 31, 2006

(51) Int. Cl. A63F 13/00

(52) U.S. Cl. 463/20

(57) ABSTRACT

A gaming machine performs a payable number control process which includes: a step of storing information regarding an accumulated value of the number of game mediums paid out to a player in a special gaming state or information regarding a value obtained by subtracting the accumulated value from a predetermined number; a step of determining based on the stored information whether or not the accumulated value of the number of game mediums paid out to the player in the special gaming state is the predetermined number or more; a step of ending the special gaming state when the accumulated value is the predetermined number or more; and a step of displaying the stored information.

### CROSS-REFERENCE TO RELATED APPLICATION

This application is based upon the prior Japanese Application No. 2004-260276, filed on Sep. 7, 2004, the entire contents of which are incorporated herein by reference.

### BACKGROUND OF THE INVENTION

1. Field of the Invention

The present invention relates to a gaming machine.

2. Description of the Related Art

A slot machine which is a so-called pachi-slot machine provided with a stop button includes a variation display device configured by arranging a plurality of mechanical rotation reels which display plural symbols in front display windows of the slot machine, or an electrical variation display device which displays symbols of the reels on a screen thereof. In response to a starting operation of a player, controlling means drives the variation display device to rotate the respective reels, thereby displaying the symbols variably. After an elapse of a fixed time, the rotations of the respective reels are sequentially stopped automatically or by a stopping operation of the player. At this time, in the case where the symbols of the respective reels appearing in the display windows make a specific combination (winning symbols), the pachi-slot machine pays out game mediums such as coins and medals, thereby giving a profit to the player.

A model of the pachi-slot machine, which is a current mainstream, includes plural kinds of winning modes. Particularly, when winning of a predetermined winning combination is established, the pachi-slot machine offers a gaming state with a better condition than a normal state for a predetermined period without limiting the payout to payout of the coins which is once performed. The winning combination as described above includes a winning combination which allows a game giving relatively large profits to the player to be performed predetermined times (which is referred to as a “big bonus”, and hereinafter, abbreviated as “BB”), and a winning combination which allows a game giving relatively small profits to the player to be performed predetermined times (which is referred to as a “regular bonus”, and hereinafter, abbreviated as “RB).

Moreover, in the model as the current mainstream, in order to make a column of a predetermined symbol combination along an activated payline (hereinafter, referred to as an “activated line”) and to establish the winning by which the coins, the medals and the like are paid out, it is required that the winning combination be won (hereinafter, referred to as “internally won”) by an internal sortition process (hereinafter, referred to as an “internal process”) and that the player performs the following operation. The operation is to stop a symbol combination showing that winning of the internally won winning combination (hereinafter, referred to as an “internal winning combination”) is established at timing when the symbol combination concerned can be stopped on the activated line. Specifically, even if the winning combination is internally won, if the timing of the stopping operation by the player is bad, the player cannot establish the winning. In other words, a gaming machine which requires a skillful technique for the timing of the stopping operation (in which more weight is placed on a technical intervention called an “observation push”) is the current mainstream.

A conventional gaming machine is disclosed in Japanese Patent Laid-Open Publication No. 2004-141481. In such a gaming machine, there is known one configured so that effect state transition means can transfer an effect state in response to the profits given to the player. According to this gaming machine, a bonus to be given to the player is updated based on the effect state transferred in response to the profits given to the player, and accordingly, a difference can be given to the profits to be given to the player depending on a gaming skill of the player and a turn of the game.

However, in the gaming machine as described above, a gaming machine which is amusing from another viewpoint is desired. Moreover, in the gaming machine as described above, a plurality of display devices which represent information regarding the winning modes are arranged discretely on the periphery of the display windows. Therefore, it is necessary for the player to roll his/her neck in order to view the respective display devices during the gaming, and accordingly, the conventional gaming machine has a problem to burden the neck of the player.

### SUMMARY OF THE INVENTION

It is an object of the present invention to provide a gaming machine which is amusing without burdening the player.

In order to achieve the above-described object, the present invention provides a gaming machine including: accumulated information storing means for storing information regarding an accumulated value of the number of game mediums given to a player by game medium giving means in a special gaming state or information regarding a value obtained by subtracting the accumulated value from a predetermined number; and accumulated information display means for displaying the information stored in the information display means.

According to the present invention, the accumulated information storing means stores the information regarding the accumulated value of the number of game mediums given to the player by the game medium giving means in the special gaming state or the information regarding the value obtained by subtracting the accumulated value from the predetermined number. Special gaming state ending means ends the special gaming state in the case where accumulated value determining means has determined that the value thus obtained represents a predetermined number or more. The accumulated information display means displays the information stored in the information storing means. The player can carry out the game while clearly grasping an ending condition of the special gaming state based on the display contents on the accumulated information display means, and accordingly, a degree of amusement of the game can be increased. Moreover, for example, in the case where the accumulated information display means displays the information regarding the value obtained by subtracting the accumulated value from the predetermined number, the player can grasp the ending condition of the special gaming state more easily.

### BRIEF DESCRIPTION OF THE DRAWINGS

FIG. 1 is a perspective view of a gaming machine.

FIG. 2 is a view showing changes of a display mode of BB-period payable number displays.

FIG. 3 is a view showing symbols arrayed on reels.

FIGS. 4A and 4B are tables showing occurrence conditions, transfer conditions, and transfer-destination gaming states of the respective gaming states.

FIG. 5 is a table showing relationships among combinations, symbol combinations, and payout numbers.

FIG. 6 is a table showing relationships among the combinations, the symbol combinations, and the payout numbers.

FIGS. 7A and 7B are probability sortition tables.

FIGS. 8A to 8C are probability sortition tables.

FIGS. 9A to 9C are probability sortition tables.

FIG. 10 is a winning combination table for stop.

FIG. 11 is a block diagram of an electric circuit built in the gaming machine.

FIG. 12 is a main flowchart of a main control circuit.

FIG. 13 is a main flowchart of the main control circuit, which follows FIG. 12.

FIG. 14 is a main flowchart of the main control circuit, which follows FIG. 13.

FIG. 15 is a flowchart showing a sliding-symbol-number deciding process.

FIG. 16 is a flowchart showing a payable number control process.

### DESCRIPTION OF THE PREFERRED EMBODIMENTS

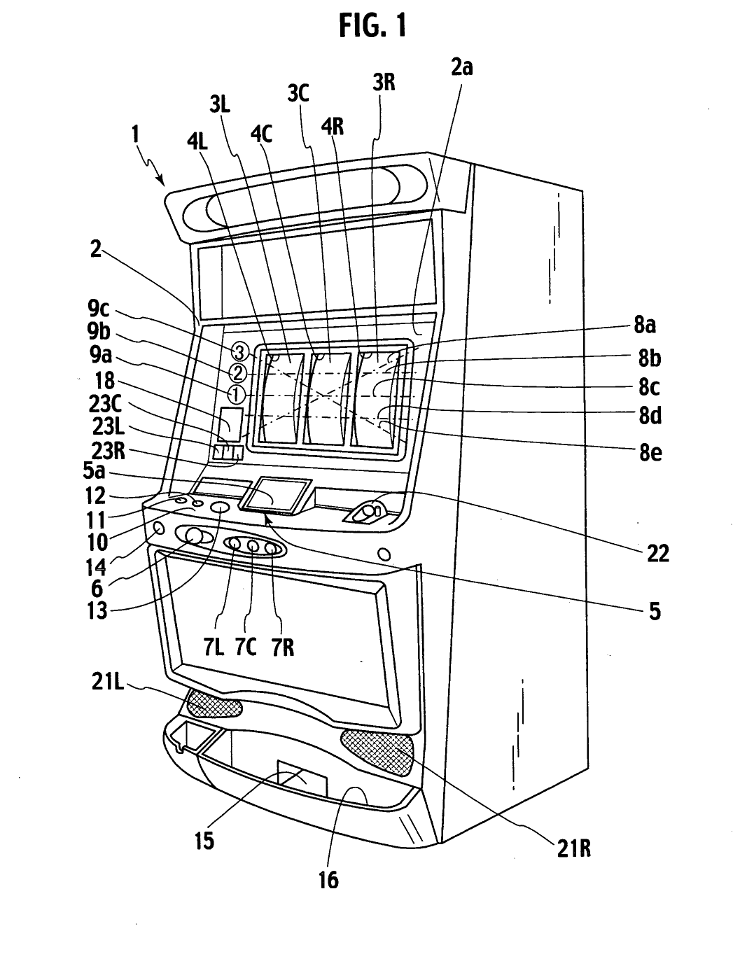

FIG. 1 is a perspective view of a gaming machine 1. The gaming machine 1 is a so-called “pachi-slot machine”. The gaming machine 1 is a gaming machine with which a game is played by using a game medium such as a card which stores information regarding a game value given or to be given to a player besides coins, medals, gaming balls, tokens, or the like. However, a description will be made below on the assumption that the medals are used.

On the front of a cabinet 2 which forms the entirety of the gaming machine 1, a panel display 2a as a substantially vertical surface is formed. On the center of the panel display 2a, vertically rectangular display windows 4L, 4C and 4R are provided. On the display windows 4L, 4C and 4R, as paylines, there are provided a top line 8b, a center line 8c, and a bottom line 8d in the horizontal direction, and a cross up line 8a and a cross down line 8e in the diagonal direction. One, three or five of these paylines are activated by operating a 1-BET switch 11, a 2-BET switch 12, or a maximum-BET switch 13, which are to be described later, respectively, or by dropping the medal into a medal insertion slit 22. Which of the paylines is activated is displayed by turning on of a BET lamp 9a, 9b or 9c to be described later.

The paylines 8a to 8e are concerned as to whether or not winning of a combination will be successfully made. Specifically, a predetermined combination (for example, a “small combination of an upper cherry (symbol 96)” to be described later) will be won in such a manner that one symbol (for example, the “upper cherry” to be described later) corresponding to the predetermined combination is statically displayed on a position (for example, a middle-stage position on the left display window 4L if the BET number to be described later is “3”) corresponding to the center line 8c, or that symbols constituting a symbol combination corresponding to the predetermined combination are statically displayed in line on predetermined positions corresponding to any of the activated lines.

In the inside of the cabinet 2, three reels 3L, 3C and 3R in which symbol columns composed of plural kinds of symbols are drawn on the respective outer circumferential surfaces thereof are provided laterally in line so as to be freely rotatable. The three reels 3L, 3C and 3R form variation display means. The symbols of the respective reels are made observable through the display windows 4L, 4C and 4R. The respective reels rotate at a constant speed (for example, 80 revolutions per minute).

On the left side of the display windows 4L, 4C and 4R, the 1-BET lamp 9a, the 2-BET lamp 9b, the maximum-BET lamp 9c, an information display portion 18, and BB-period payable number displays 23L, 23C and 23R are provided. The 1-BET lamp 9a, the 2-BET lamp 9b, and the maximum-BET lamp 9c are turned on in response to the number of medals (hereinafter, referred to as a “BET number”) bet for playing one game.

The 1-BET lamp 9a is turned on when the BET number is “1” and one payline is activated (one activated line is set). The 2-BET lamp 9b is turned on when the BET number is “2” and three paylines are activated (three activated lines are set). The maximum-BET lamp 9c is turned on when the BET number is “3” and all (five) the paylines are activated (all (five) the activated lines are set). The information display portion 18 is composed of a 7-segment LED, and displays the number of reserved (credited) medals, the number of payout medals at the time of winning, and the like.

The BB-period payable number displays 23L, 23C and 23R display the number of medals (the minimum number of medals) of which payout is receivable by the player in a BB gaming state to be described later. Specifically, the BB-period payable number displays 23L, 23C and 23R display the number of medals (the minimum number of medals) paid out by the gaming machine 1 during a period until the BB gaming state to be described later is ended (until the gaming state is transferred to a normal state to be described later).

When the BB-period payable number displays 23L, 23C and 23R display 0, a condition for the above-described transfer is satisfied. The player can grasp the minimum number of medals of which payout is receivable in the BB gaming state by the display of the BB-period payable number displays 23L, 23C and 23R. Accordingly, the player can appropriately grasp the gaming state, and can enjoy the game in the BB gaming state with peace of mind.

Below the display windows 4L, 4C and 4R, a base portion 10 as a horizontal plane is formed. A liquid crystal display device 5 is provided between the base portion 10 and the display windows 4L, 4C and 4R. On a display screen 5a of the liquid crystal display device 5, information regarding the game, for example, information to the effect that a big bonus or a challenge time, which are to be described later, is internally won or carried over, and so on, are displayed. On the right side of the liquid crystal display device 5, the medal insertion slit 22 is provided. On the left side of the liquid crystal display device 5, the 1-BET switch 11, the 2-BET switch 12, and the maximum-BET switch 13 are provided.

By one pressing operation of the 1-BET switch 11, one of the credited medals is bet on the game. By one pressing operation of the 2-BET switch 12, two of the credited medals are bet on the game. By pressing the maximum-BET switch 13, the maximum number of medals capable of being bet on one game are bet thereon. By operating these BET switches 11, 12 and 13, the predetermined paylines are activated as described above.

On the left side on the front face of the base portion 10, a C/P switch 14 is provided, in which the credit/payout of the medals earned by the player from the game is switched by an operation to press a button. By switching the C/P switch 14, the medals are paid out from a medal payout opening 15 on a lower portion of the front face of the cabinet 2, and the medals thus paid out are reserved in a medal receiving tray 16. Onto the right side of the C/P switch 14, a start lever 6 for rotating the above-described reels by an operation of the player and starting variation display of the symbols in the display windows 4L, 4C and 4R is attached so as to be freely rotatable within a predetermined angle range.

On the center of the front face of the base portion 10, which is also a position below the liquid crystal display device 5, three stop buttons (stopping operation means) 7L, 7C and 7R for stopping the rotations of the three reels 3L, 3C and 3R, respectively, are provided. On the right and left above the medal receiving 16, speakers 21L and 21R are provided. In this embodiment, one game (a unit game) is started by the operation of the start lever 6, and is ended when all the reels 3L, 3C and 3R are stopped.

In this embodiment, for one or the plurality of reels, the maximum values of the numbers of sliding symbols (the maximum numbers of sliding displays) in a challenge game state period and a single challenge game state period, which are to be described later, are set at “1”. Moreover, the maximum values of the numbers of sliding symbols in gaming state periods other than the challenge game state period and the single challenge game state period are set at “4”. The “number of sliding symbols” is the number of symbols displayed for a period from the operation of the stop buttons 7L, 7C and 7R (from detection of the operation) to the stop of the reels 3L, 3C and 3R. Moreover, the “number of sliding symbols” is the number of moving symbols (a moving amount of the symbols) for the period from the operation of the stop buttons 7L, 7C and 7R to the stop of the reels 3L, 3C and 3R corresponding thereto. Specifically, the numbers of sliding symbols coincide with the numbers of symbols of which centers cross the predetermined payline such as the center line 8c for the period from the operation of the stop buttons 7L, 7C and 7R to the stop of the reels 3L, 3C and 3R corresponding thereto.

Moreover, one or the plurality of reels 3L, 3C and 3R are controlled to be stopped within a predetermined time (for example, 75 ms) after the stop buttons 7L, 7C and 7R are operated in the challenge game state period and the single challenge game state period, which are to be described later. Furthermore, one or the plurality of reels 3L, 3C and 3R are control led to be stopped within a predetermined time (for example, 190 ms) after the above-described stopping operation in the gaming state periods other than the challenge game state period and the single challenge game state period. Specifically, plural kinds of gaming states in which the maximum times from the operation of the stop buttons 7L, 7C and 7R to the stop of the reels 3L, 3C and 3R differ from one another can also be provided.

Moreover, in this embodiment, the stopping operation of the reels (the operation of the stop button) performed when all the reels are rotating is referred to as a “first stopping operation”, the stopping operation of the reels performed after the “first stopping operation” is referred to as a “second stopping operation”, and the stopping operation of the reels performed after the “second stopping operation” is referred to as a “third stopping operation”.

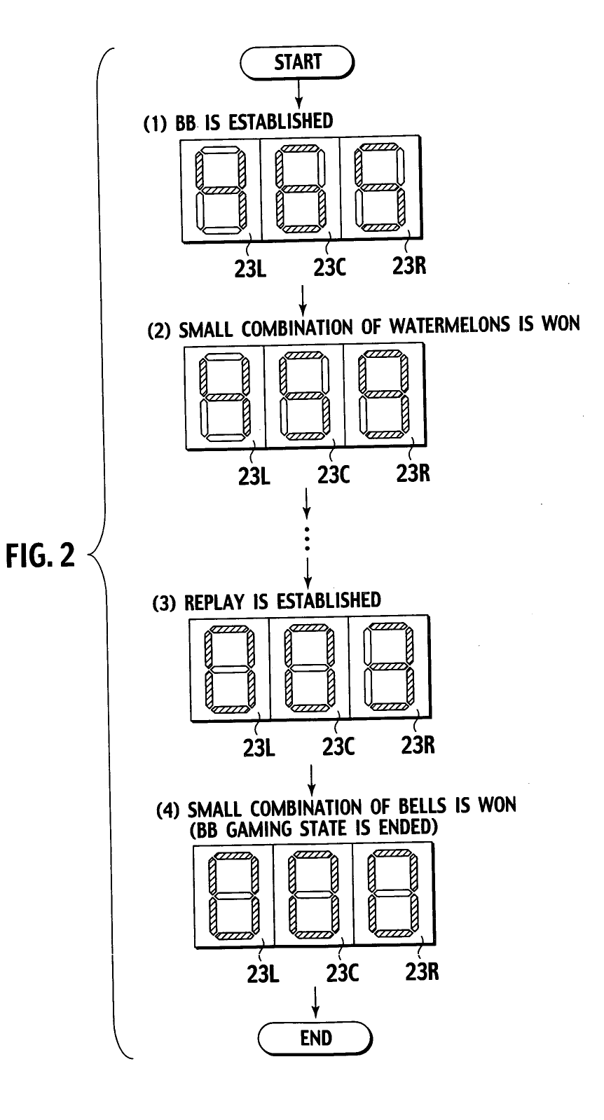

FIG. 2 shows changes of a display mode of the BB-period payable number displays 23L, 23C and 23R in a period from the establishment of the BB to the end of the BB gaming state to be described later. These displays are composed of 7-segment LEDs.

In FIG. 2(1), the BB is established (the symbol combination corresponding to the BB is arrayed along the activated line), and 465 (a predetermined number) is displayed as the minimum total payout number of medals, which is an ending condition of the BB gaming state to be described later.

The BB gaming state to be described later is basically ended when 465 medals (the minimum total payout number) are paid out; however, in some cases, a combination in which the payout number is 15 is won when the total payout number is 464 (the display displays 1), and the maximum total payout number in the BB gaming state is 479.

In FIG. 2(2), a small combination of a watermelon to be described later (in which the payout number is 6) is won, and 459 (465-6) is displayed as the rest of the total payout number (a value obtained by subtracting an accumulated value from the predetermined number).

In FIG. 2(3), it is displayed that a replay to be described later is established. Since the replay does not constitute the winning (in which the payout number of medals is 0), the display mode of the display is not changed owing to the establishment of the replay. The BB-period payable number displays 23L, 23C and 23R display 3.

In FIG. 2(4), a small combination of a bell to be described later (in which the payout number is 10) is won, and 0 is displayed as the rest of the total payout number. The small combination of the bell is won in a situation where the BB-period payable number displays 23L, 23C and 23R display 3, and accordingly, the total payout number of medals in the BB gaming state becomes 472, which satisfy the ending condition of the BB gaming state.

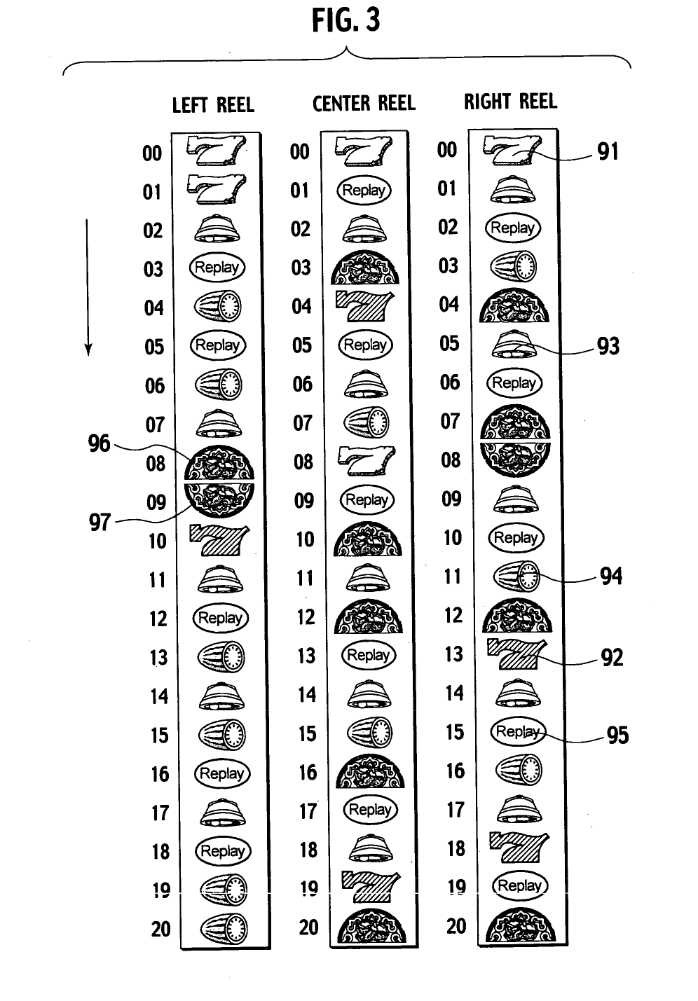

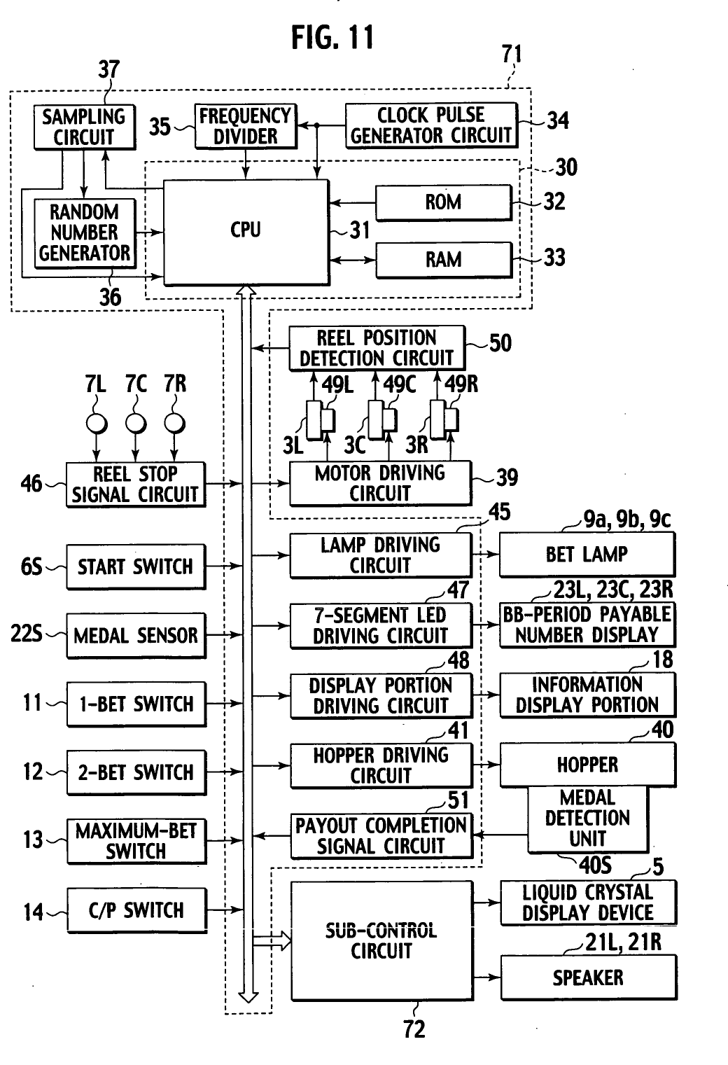

FIG. 3 shows symbol columns in each of which 21 pieces of plural kinds of symbols shown on each of the reels 3L, 3C and 3R are arrayed. Code numbers “00” to “20” are added to the respective symbols, and are stored (memorized) as a data table in a RCM 32 (in FIG. 11) to be described later. On each of the reels 3L, 3C and 3R, the symbol column is shown, which is composed of the symbols of “white 7 (symbol 91)”, “red 7 (symbol 92)”, “bell (symbol 93)”, “watermelon (symbol 94)”, “Replay (symbol 95), “upper cherry (symbol 96), and “lower cherry (symbol 97). The respective reels 3L, 3C and 3R are rotationally driven so that the symbol columns can move in the arrow direction of FIG. 3.

As the combinations of this embodiment, there are provided the BB, a challenge time (hereinafter, abbreviated as “CT”), the RB, a single bonus (hereinafter, abbreviated as “SB”), a single challenge time (hereinafter, abbreviated as “SCT”), Replay, the small combination of the watermelon, the small combination of the bell, the small combination of the upper cherry, a small combination of the lower cherry, and a small combination of JAC.

The BB is a combination continuous operation device according to a first-type special combination. The RB is the first-type special combination. A challenge game to be described later is a second-type special combination. The SCT is a condition for the operation of the second-type special combination. The CT is a combination continuous operation device according to the second-type special combination. The SB is a regular combination.

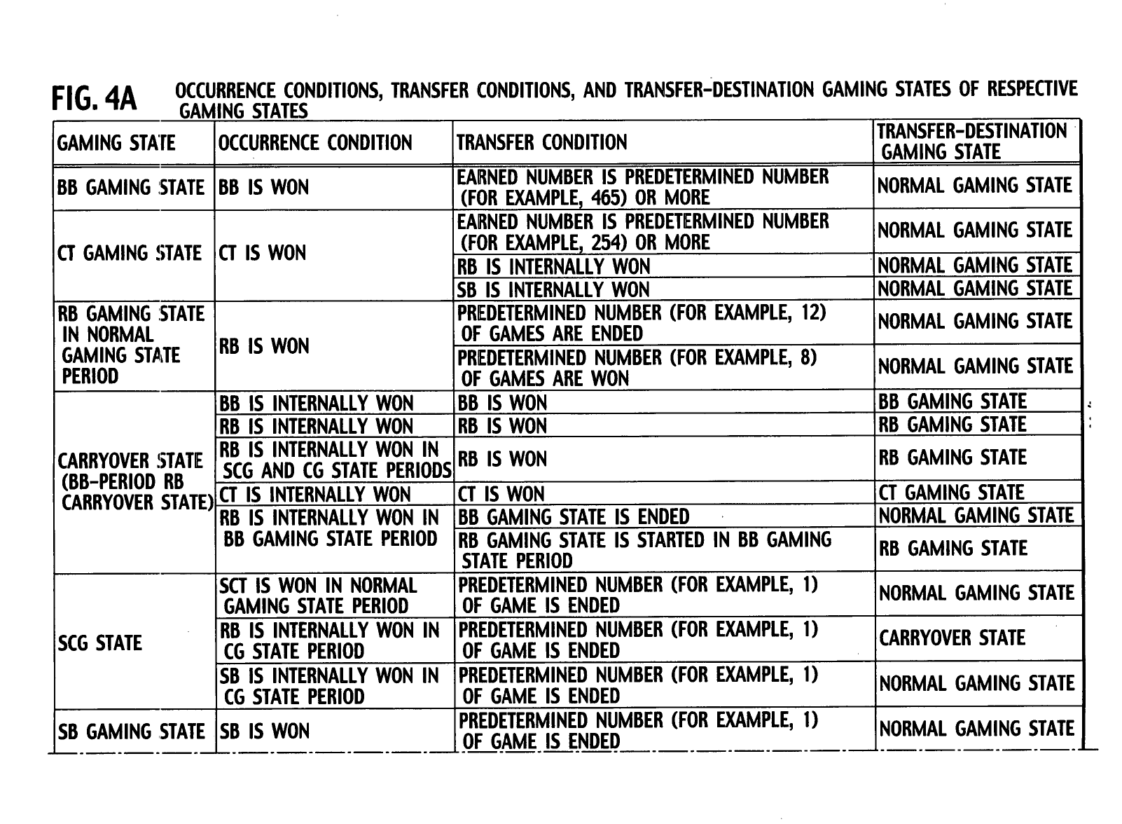

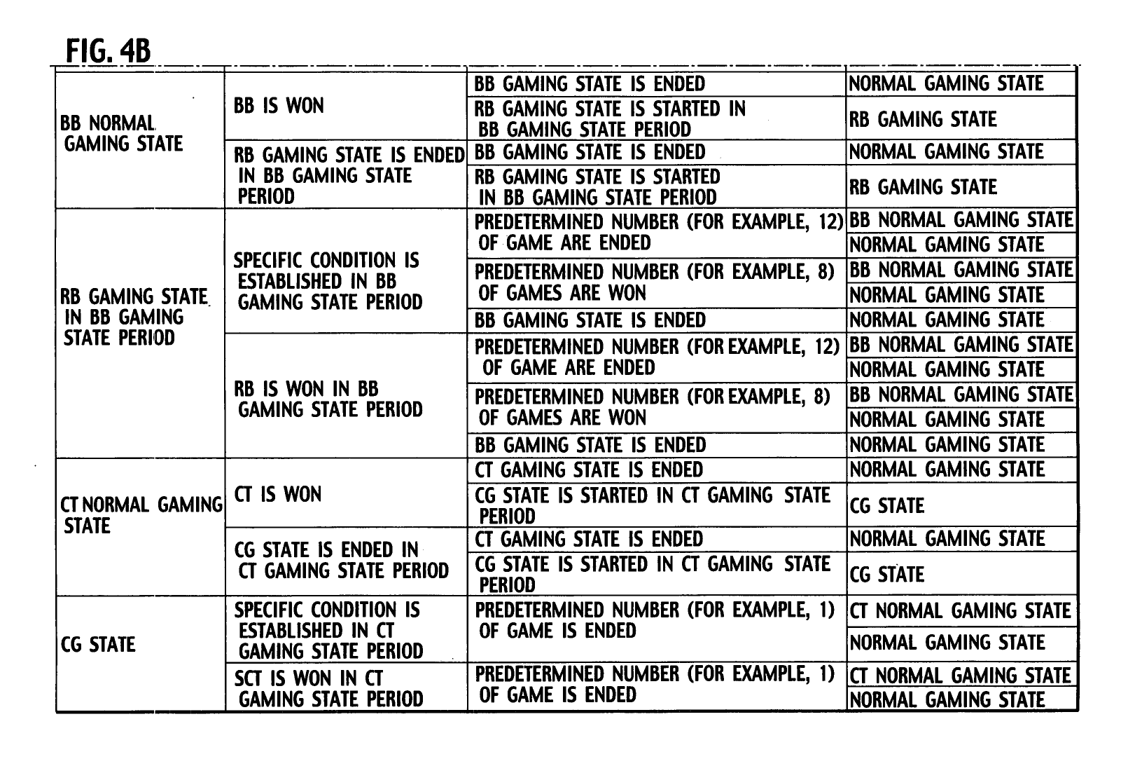

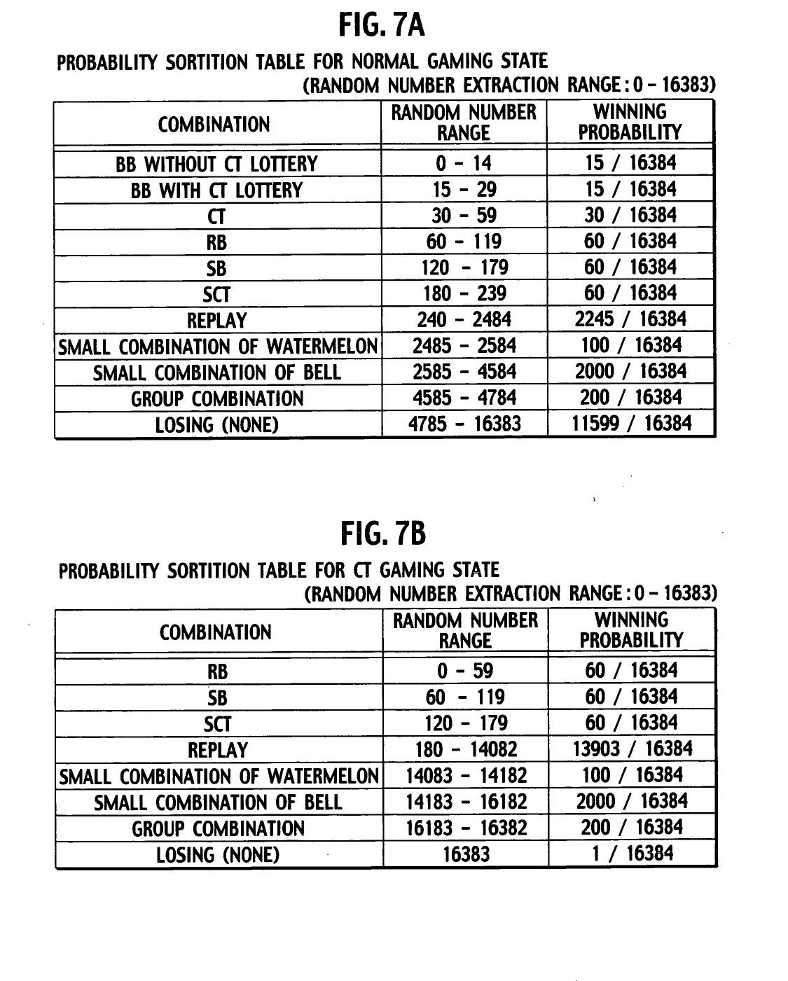

FIGS. 4A and 4B show occurrence conditions, transfer conditions, and transfer-destination gaming states of the respective gaming states when the transfer conditions are satisfied. A description will be made later with reference to FIG. 7 to FIG. 10 of gaming characteristics (for example, modes of stop controls for the reels 3L, 3C and 3R in response to a winning combination for reel-stop, which is to be described later) of the respective gaming states.

The gaming states of this embodiment includes a normal gaming state, a BB gaming sate, a challenge time gaming state (hereinafter, abbreviated as a “CT gaming state”), an RB gaming state, a single challenge game state (hereinafter, abbreviated as an “SCG state”, a BB carryover state, a challenge time carryover state (hereinafter, referred to as a “CT carryover state”), an RB carryover state, and a single bonus gaming state (hereinafter, abbreviated as an “SB gaming state”). Hereinafter, the BB carryover state, the CT carryover state, and the RB carryover state are referred to as a “carryover state”. Hereinafter, a combination carried over during this carryover state is referred to as a “carryover combination”.

The BB in this embodiment includes a BB without a CT lottery, and a BB with the CT lottery. When the BB without the CT lottery is won, a first BB gaming state to be described later occurs. Moreover, when the BB with the CT lottery is won, a second BB gaming state to be described later occurs.

The normal gaming state is a gaming state where an expectation value of a “winning rate (a game value to be given to the player with respect to a unit game value bet on the game) is less than “1”. Moreover, the normal gaming state is a gaming state without the carryover combination to be described later, which is the most disadvantageous gaming state for the player among the gaming states.

The BB gaming state is a gaming state composed of a BB normal gaming state and the RB gaming state. Moreover, the BB gaming state is a gaming state composed of a game in which the “combination continuous operation device according to the first-type special combination” is operated.

The BB gaming state includes the first BB gaming state, and the second BB gaming state. Ending conditions of these gaming states (the transfer conditions thereof to the other gaming states) differ therebetween. Moreover, when the second BB gaming state is ended, a lottery as to whether or not the gaming state concerned is to be transferred to the CT gaming state is performed; however, when the first BB gaming state is ended, such a lottery is not performed.

The CT gaming state is a gaming state composed of a CT normal gaming state and a challenge game state (hereinafter, abbreviated as a “CG state”). Hereinafter, a game in the CG state period or the SCG state period is referred to as a “challenge game”. Moreover, the CT gaming state is a gaming state composed of a game in which the “combination continuous operation device according to the second-type special combination” is operated.

The SCG state and the CG state are gaming states composed of games in which the “second-type special combinations” are operated.

The RB gaming state is a gaming state composed of a game in which the “first-type special combination” is operated.

The gaming characteristics in the CG state period and the SCG state period are similar to each other; however, there are soe differences such that the SCG state is started in the normal gaming state period while the CG state is started (occurs) in the CT normal gaming state period.

The BB carryover state is a gaming state where the winning of the BB is allowed over one or the plurality of games.

The CT carryover state is a gaming state where the winning of the CT is allowed over one or the plurality of games.

The RB carryover state is a gaming state where the winning of the RB is allowed over one or the plurality of games.

Here, owing to the fact that a specific condition is satisfied in the BB normal gaming state, the RB gaming state occurs (the gaming state is transferred to the RB gaming state) without winning the RB (without statically displaying “red 7-red 7-white 7” in line along the activated line). Moreover, when the RB is internally won in the BB gaming state (the BB normal gaming state, and the RB gaming state in the BB gaming state period), the RB carryover state (the RB carryover state in the BB period) is generated over one or the plurality of games in the BB gaming state period. When the RB is won, the gaming state is transferred from the RB carryover state (RB carryover state in the BB period) to the RB gaming state in the BB gaming state period.

Moreover, when the RB is internally won in the BB gaming state period, or when the RB is not won in the RB carryover state but a specific condition is established, the gaming state can be transferred from the current gaming state (for example, the RB gaming state in the BB period) to the RB gaming state in the BB gaming state period. However, when the ending condition of the BB gaming state is established in the RB carryover state (the RB carryover state in the BB period) period, the gaming state is transferred from the RB carryover state (the RB carryover state in the BB period) to the normal gaming state. Meanwhile, the RB is internally won in the normal gaming state period, and thus the gaming state is transferred to the RB carryover state, and the RB is carried over.

The SB gaming state is a gaming state composed of a game in which the “regular combination” is operated.

As shown in FIGS. 4A and 4B, the occurrence condition of the BB gaming state is the winning of the BB. The earned number (for example, a so-called “net increase number” or a “payout number”) reaches the predetermined number (for example, 465), and thus the transfer condition of the gaming state is established (satisfied), and the gaming state is transferred to the normal gaming state.

The first BB gaming state is ended in response to the fact that one of the following conditions is established, which are: that the net increase number reaches “465 or more”; and that the “third” RB gaming state is ended. Then, the gaming state is transferred to the other gaming state.

Moreover, the second BB gaming state is ended in response to the fact that one of the following conditions is established, which are: that the net increase number reaches “241 or more”; and that the “second” RB gaming state is ended. Then, the gaming is transferred to the other gaming state.

When the second BB gaming state is ended, the lottery as to whether or not the gaming state is to be transferred to the CT gaming state is performed. A winning probability of the lottery is “½” in this embodiment. When the lottery is won, the gaming state is transferred to the CT gaming state, and when the lottery is not won, the gaming state is transferred to the normal gaming state.

The occurrence condition of the CT gaming state is that the CT to be described later is won, or that the lottery in the case where the second BB gaming state is ended is won. When the CT is internally won, the CT concerned is distributed to either a CT1 or a CT2 by a lottery. The transfer condition is established by the fact that any of the following conditions is established, which are: that the earned number reaches a predetermined number (for example, 254) or more, that the RB is internally won; and that an SB to be described later is internally won. Then, the gaming state is transferred to the normal gaming state.

The occurrence condition of the RB gaming state in the normal gaming state period is the winning of the RB. The transfer condition is established by the fact that any of the following conditions is established, which are: that a predetermined number (for example, 12) of games are ended; and that a predetermined number (for example, 8) of winnings are realized. Then, the gaming state is transferred to the normal gaming state.

The occurrence condition of the carryover state is any of the following conditions, which are: that the BB is internally won; that the RB is internally won; the RB is internally won in the SCG and CG state periods; the CT is internally won; and the RB is internally won in the BB gaming state period. The transfer condition is established by the fact that the BB, the RB, or the CT is won, that the BB gaming state is ended, or that the RB gaming state is started in the BB gaming state period. Then, the gaming state is transferred to the BB gaming state, the RB gaming state, the CT gaming state, or the normal gaming state.

The occurrence condition of the SCG state is the winning of the SCT to be described later in the normal gaming state period besides the case where the RB or the SB is internally won in the OG state period. In any of the cases, the transfer condition is established by the fact that a predetermined number (for example, 1) of game is ended. Then, the gaming state is transferred to the normal gaming state, the RB gaming state, the SB gaming state, or the carryover state (the RB carryover state).

The occurrence condition of the SB gaming state is the winning of the SB to be described later. The transfer condition is established by the fact that a predetermined number (for example, 1) of game is ended. Then, the gaming state is transferred to the normal gaming state.

The occurrence condition of the BB normal gaming state is that the BB is won or that the RB gaming state is ended in the BB gaming state period. The transfer condition is established by the fact that the BB gaming state is ended or that the RB gaming state is started in the BB gaming state period. Then, the gaming state is transferred to the normal gaming state or the RB gaming state.

The occurrence condition of the RB gaming state in the BB gaming state period is that a specific condition is established in the RB gaming state in the BB normal gaming state period or the BB gaming state period, or that the RB is won in the BB normal gaming state period or the RB gaming state period in the BB gaming state. The transfer condition is established by the fact that any of the following conditions is established, which are: that the predetermined number (for example, 12) of games are ended; that the predetermined number (for example, 8) of winnings are realized; and that the BB gaming state is ended. Then, the gaming state is transferred to the normal gaming state, the RB gaming state in the BB gaming state period, or the BB normal gaming state.

The occurrence condition of the CT normal gaming state is that the CT to be described later is won or that the CG state is ended in the CT gaming state period. The transfer condition is established by the fact that the CT gaming state is ended or that the OG state is started in the CT gaming state period. Then, the gaming state is transferred to the normal gaming state or the CG state.

When the RB or the SB is internally won in the CT normal gaming state period, the gaming state is transferred to the normal gaming state or the carryover state. When the RB is internally won in the CG state period, the challenge game is played in the game thus won internally. When the RB is won in the game concerned, the gaming state is transferred to the RB gaming state. When the RB cannot be won, the gaming state is transferred to the carryover gaming state. When the SB is internally won in the CG state period, the challenge game is played in the game thus won internally. When the SB is won in the game, the gaming state is transferred to the SB gaming state. When the SB cannot be won, the gaming state is transferred to the normal gaming state.

The occurrence condition of the CG state is that a specific condition is established in the CT normal gaming state period or that the SCT is won. In the CT normal gaming state, not the SCT state but the CG state occurs when the SCT is won. The transfer condition is established by the fact that a predetermined number (for example, one or the plurality) of games are ended. Then, the gaming state is transferred to the normal gaming state or the CT normal gaming state.

Hereinafter, the CG state generated in the CT1 started on an occasion of the winning of the CT and the establishment of the predetermined condition is referred to as a “CT1-period CG state”. Moreover, the CG state generated in the CT2 started on an occasion of the winning of the CT and the establishment of the predetermined condition is referred to as a “CT2-period CG state”.

The payout number of medals of the combinations such as the BB, the RB, the CT, and the SB may also be set at 0. Moreover, in this embodiment, though the BB without the CT lottery and the BB with the CT lottery are provided, it is also possible not to provide the BB with the CT lottery. Furthermore, it is also possible to provide plural kinds of BBs in which the ending conditions of the BB gaming states differ form one another (to provide ending condition deciding means for deciding the ending condition for each of the BBs). In such a way, a variety of the game is increased, and an interest of the game is enhanced.

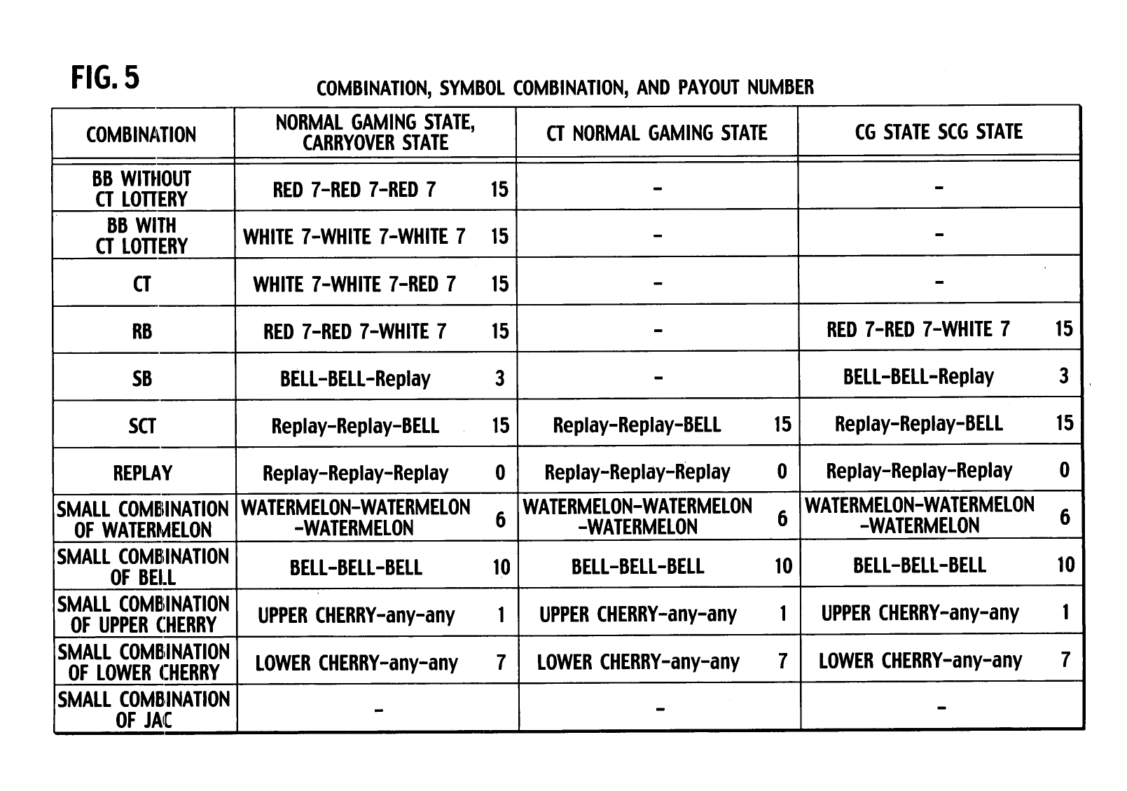

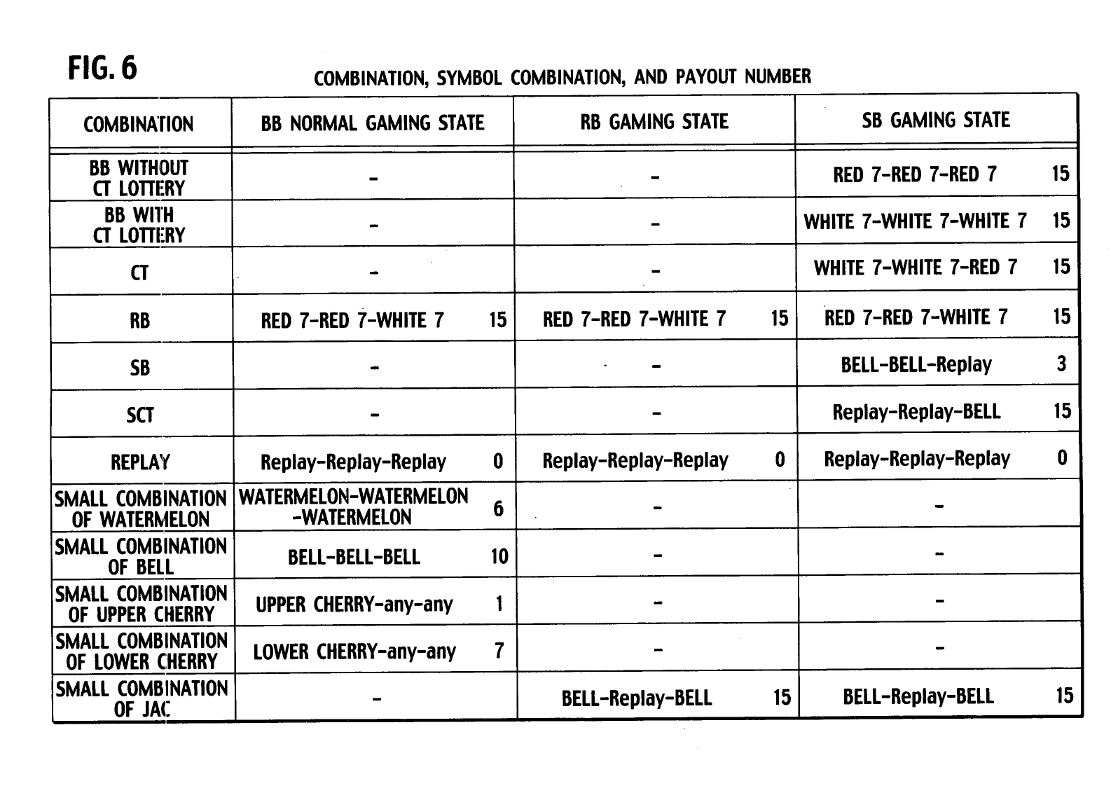

A description will be made of the combinations, the symbol combinations, and the payout numbers with reference to FIG. 5 and FIG. 6.

The winning of the BB without the CT lottery is realized in such a manner that “red 7-red 7-red 7” is arrayed along the activated line.

The winning of the BB with the CT lottery is realized in such a manner that “white 7-white 7-white 7” is arrayed along the activated line.

The winning of the CT is realized in such a manner that “white 7-white 7-red 7” is arrayed along the activated line.

The winning of the RB is realized in such a manner that “red 7-red 7-white 7” is arrayed along the activated line.

The winning of the SB is realized in such a manner that “bell-bell-Replay” is arrayed along the activated line.

The winning of the SCT is realized in such a manner that “Replay-Replay-bell” is arrayed along the activated line.

The winning of the Replay is realized in such a manner that “Replay-Replay-Replay” is arrayed along the activated line. When the Replay is won, the same number of medals as the number of dropped medals is automatically dropped, and accordingly, the player can play the next game without consuming the medals. Specifically, the Replay is a combination in which the winning thereof allows the game to be played without dropping the game value.

Moreover, the combinations of the symbols in which the “small combination of the watermelon”, the “small combination of the bell”, the “small combination of the upper cherry”, and the “small combination of the lower cherry” are won are as shown in the table.

The winnings of the “small combination of the upper cherry” and the “small combination of the lower cherry” are realized in the case where the “upper cherry (symbol 96)” and the “lower cherry (symbol 97)” are statically displayed on the left display window 4L, respectively. As shown in FIG. 3, these “upper cherry” and “lower cherry” are arranged so as to be adjacent to each other on the left reel 3L.

Hence, there is a case where the winnings of the “small combination of the upper cherry” and the “small combination of the lower cherry” are established simultaneously (hereinafter, this case is referred to as a “large-cherry small combination”). The payout number in this case is “9” or “15”.

The winning of the small combination of the JAC is realized in such a manner that “bell-Replay-bell” is arrayed in the RB gaming state period and the SB gaming state period.

In the normal gaming state or the carryover state, there is a case where the combinations other than the small combination of the JAC are won. However, in the BB carryover state, there is no case where the SB, the SCT, the CT, and the RB are won. Moreover, in the CT carryover state, there is no case where the SB, the SCT, the BB, and the RB are won. Furthermore, in the RB carryover state, there is no case where the SB, the SCT, the BB, and the CT are won. Furthermore, in the RB carryover state in the BB gaming state period (the BB-period RB carryover state), there is not case where the SB, the SCT, the BB, and the CT are won.

In the CT normal gaming state, there is a case where the combinations other than the BB, the CT, the RB, the SB, and the small combination of the JAC are won.

In the CG state, there is a case where the combinations other than the BB, the CT, and the small combination of the JAC are won. In the SCG state, there is a case where the combinations other than the small combination of the JAC are won. In FIG. 5, an illustration of the combination BB, the symbol combination “red 7-red 7-red 7” and the payout number 15 in the SCG state, and an illustration of the combination CT, the symbol combination “white 7-white 7-red 7” and the payout number 15 in the SCG state are omitted.

In the BB normal gaming state, there is a case where the RB, the Replay, the small combination of the watermelon, the small combination of the bell, the small combination of the upper cherry, or the small combination of the lower cherry is won.

In the RB gaming state in the normal gaming state period, there is a case where the Replay or the small combination of the JAC is won. Moreover, in the RB gaming state in the BB gaming state period, there is a case where the RB, the Replay, or the small combination of the JAC is won.

In the SB gaming state, there is a case where the combinations other than the small combination of the watermelon, the small combination of the bell, the small combination of the upper cherry, and the small combination of the lower cherry are won.

A description will be made of probability sortition tables with reference to FIG. 7A to FIG. 9C.

FIG. 7A shows a probability sortition table for the normal gaming state. In the normal gaming state, there is a case where any of the combinations other than the small combination of the JAC is internally won.

FIG. 7B shows a probability sortition table for the CT gaming state. In the CT gaming state, there is a case where any of the combinations other than the small combinations of the BB, the CT, and the JAC is internally won. In any of the cases of the CT normal gaming state and the CG state, the internally won combination is decided based on the probability sortition table shown in FIG. 7B; however, the winning combinations for reel-stop are selected in different modes (the winning combination for reel-stop is decided based on different kinds of information (different lottery values).

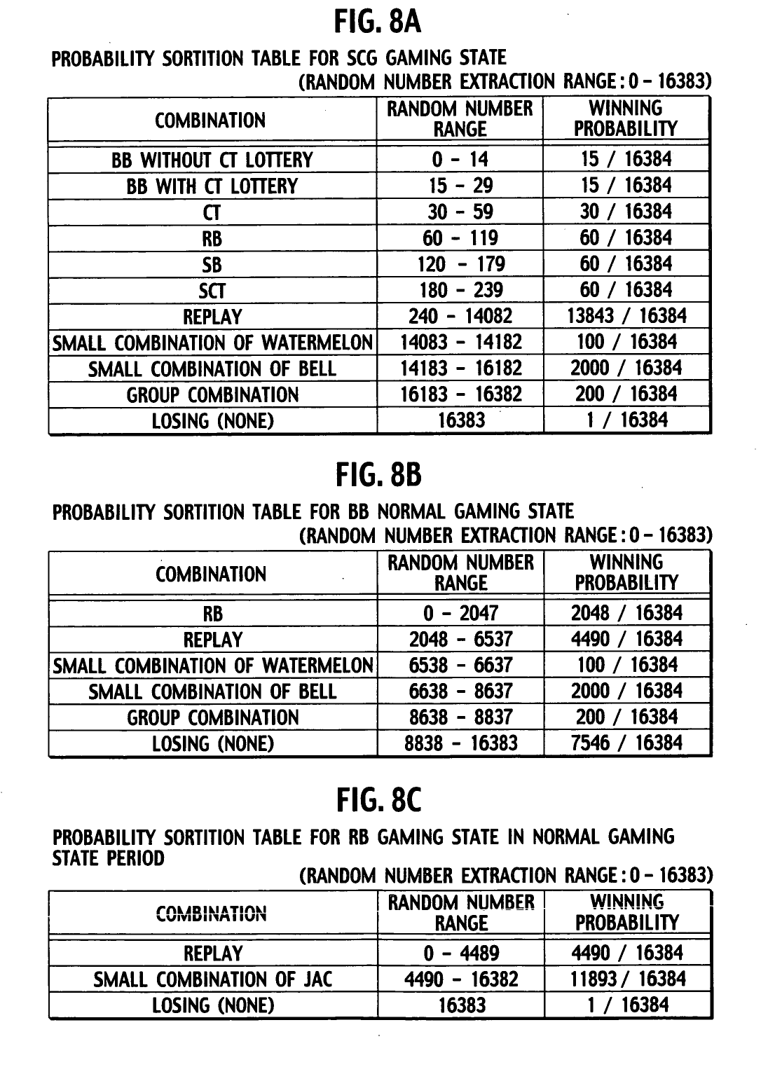

FIG. 8A shows a probability sortition table for the SCG gaming state. In the SCG state, there is a case where any of the combinations other than the small combination of the JAC is internally won.

FIG. 8B shows a probability sortition table for the BB normal gaming state. In the BB normal gaming state, any of the BB, the Replay, the small combination of the watermelon, the small combination of the bell, a group combination, and a losing (none) is internally won. In the BB normal gaming state period, though the gaming state may be transferred to the RB gaming state irrespective of the internally won combination, the gaming state can also be transferred to the RB gaming state in the BB gaming state period through the BB-period RB carryover state as the condition where the gaming state is transferred thereto.

FIG. 8C shows a probability sortition table for the RB gaming state in the normal gaming state period. In the RB gaming state, any of the Replay, the small combination of the JAC, and the losing (none) is internally won.

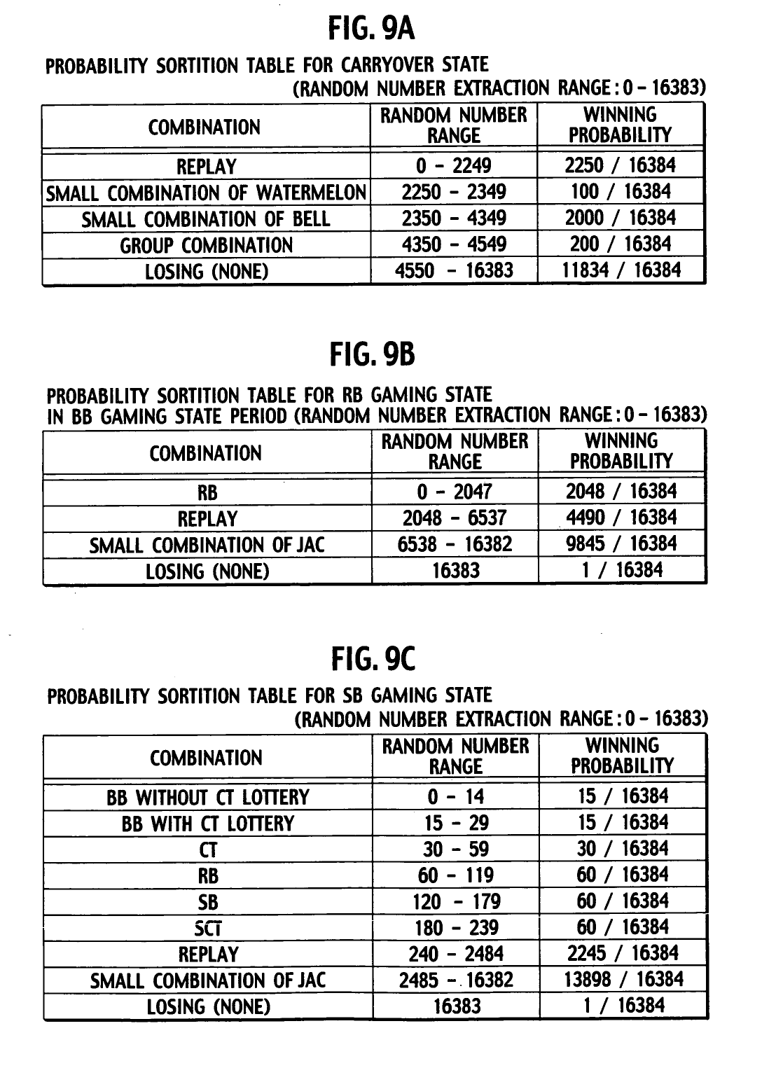

FIG. 9A shows a probability sortition table for the carryover state. In the carryover state, any of the Replay, the small combination of the watermelon, the small combination of the bell, the group combination, and the losing (none) is internally won.

FIG. 9B shows a probability sortition table for the RB gaming state in the BB gaming state period. In the RB gaming state in the BB gaming state period, any of the RB, the Replay, the small combination of the JAC, and the losing (none) is internally won. Moreover, in the BB normal gaming state, which is also the BB-period RB carryover state, a table obtained by removing the RB from the above-described probability sortition table for the BB gaming state, which is shown in FIG. 8B, is used. With regard to the sortition probability, only the probability of the combination RB becomes “0” (where the probability to internally win the RB becomes 0), and the probabilities of the other combinations are set similar to the above (the probability of the losing may be changed). In the RB gaming state in the BB gaming state period, which is also the BB-period RB carryover state, a table obtained by removing the RB from the above described probability sortition table for the RB gaming state in the BB gaming state period, which is shown in FIG. 9B, (a table in which the RB is not selected as the internally won combination) is used. With regard to the sortition probability, only the probability of the combination RB becomes “0”, and the probabilities of the other combinations are set similar to the above.

FIG. 9C shows a probability sortition table for the SB gaming state. In the SB gaming state, any of the BB without the CT lottery, the BB with the CT lottery, the CT, the RB, the SB, the SCT, the Replay, the small combination of the JAC, and the losing (none) is won.

The probability sortition tables are provided for each of setting values (settings) provided at plural stages (for example, 6 stages); however, the probability sortition tables for each of the setting values are omitted. The setting values are values set (selected) by a game arcade manager, and in response to the setting values, degrees of advantage for the player in the game (for example, the winning rate, the internal winning probability of the combination, and the like) differ from one another. In this embodiment, “1” to “6” are provided as the setting values. The probability to internally win at least any of the combination such as the BB, the CT, the RB, the SB, and the SCT is set to differ between at least any of “two” setting values. Moreover, the internally won combination can be decided by using one probability sortition table for all of the setting values, and winning combination tables for stop for use in deciding the winning combination for reel-stop, which is to be described later, can be made to differ from one another in response to the settings.

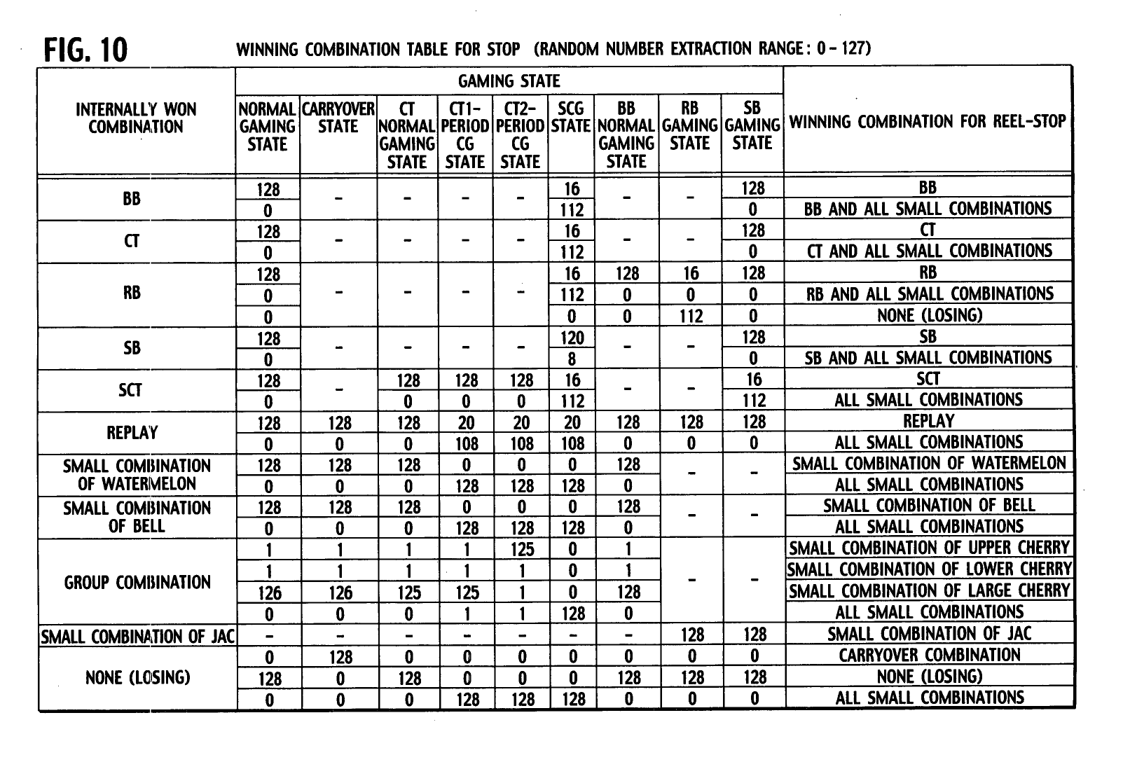

A description will be made of the winning combination table for stop with reference to FIG. 10.

In the winning combination table for stop, lottery values which bring the winnings of the winning combinations for reel-stop are shown for each of the internally won combinations and the gaming states.

The winning combinations for reel-stop are information for use in the control to stop the reels 3L, 3C and 3R. When the winning combination for reel-stop is decided, the reels 3L, 3C and 3R are controlled to be stopped in a state where a stop mode of the symbols or the symbol combination, which corresponds to the combination concerned, is allowed to be statically displayed on the display windows 4L, 4C and 4R. Moreover, such a stop control is performed in a state where the symbols or the symbol combinations, which correspond to the combinations other than the winning combination for reel-stop, are not allowed.

The lottery values are values subtracted from extracted random number values. When a value obtained by subtracting each lottery value from each random number value is negative, the information (the winning combination for reel-stop) corresponding to the lottery value is selected. An extraction range of the random numbers is “0” to “127”. For example, in the case where the internally won combination is the Replay in the SCG state period, when the extracted random number value is “30”, the lottery value “20” corresponding to the Replay as the winning combination for reel-stop is first subtracted from “30”. A value obtained by the subtraction is “10” (which is a positive value). Next, a lottery value “108” corresponding to all the small combinations as the winning combinations for reel-stop is subtracted from “10”. A value obtained by the subtraction becomes negative. Hence, all the small combinations are selected as the winning combinations for reel-stop.

The maximum number of sliding symbols of the reels, which corresponds to the first stopping operation, is set at “1”. The number of sliding symbols (the maximum number of sliding symbols) of the reels, which corresponds to the second stopping operation and the third stopping operation, is set at “0”. However, when the small combination is not included in the winning combination for reel-stop, the number of sliding symbols (the maximum number of sliding symbols) is set at “1”.

Specifically, when all the small combinations are selected as the winning combination for reel-stop, all the small combinations are allowed to be won; however, whether or not the winning thereof is successfully made will depend on the operation timing of the stop buttons by the player. In a similar way, also when the combination other than the Replay is set for the winning combination for reel-stop, whether or not the winning thereof is successfully made will depend on the operation timing of the stop buttons 7L, 7C and 7R by the player.

When the internally won combination is the BB, the BB is selected as the winning combination for reel-stop in the normal gaming state and the SB gaming state. Meanwhile, in the SCG state, either the BB or the “BB and all the small combinations” is selected as the winning combination for reel-stop.

When the internally won combination is the CT, the CT is selected as the winning combination for reel-stop in the normal gaming state and the SB gaming state. Meanwhile, in the SCG state, either the CT or the “Cr and all the small combinations” is selected as the winning combination for reel-stop.

When the internally won combination is the RB, the RB is selected as the winning combination for reel-stop in the normal gaming state, the BB gaming state, and the SB gaming state. Meanwhile, in the SCG state, either the RB or the “RB and all the small combinations” is selected as the winning combination for reel-stop. Moreover, in the RB gaming state, the RB or the “none (losing)” is selected as the winning combination for reel-stop. When the RB is internally won in the RB gaming state, the RB is carried over.

When the internally won combination is the SB, the SB is selected as the winning combination for reel-stop in the normal gaming state and the SB gaming state. Meanwhile, in the SCG state, either the SB or the “SB and all the small combinations” is selected as the winning combination for reel-stop.

When the internally won combination is the SCT, the SCT is selected as the winning combination for reel-stop in the gaming states other than the SCG state and the SB gaming state. Meanwhile, in the SCG state and the SB gaming state, either the SCT or all the small combinations are selected as the winning combination for reel-stop (it is decided whether or not the winning of the SCT is allowed in the SCG state by a predetermined lottery).

The gaming state of the next game to the game in which the SCT is won in the normal gaming state period becomes the SCG state. When the SCT is internally won in the SOG state period, and the SCT is selected as the winning combination for reel-stop, the gaming state of the next game thereto also becomes the SCG state. Specifically, on an occasion of the winning of the SCT, the gaming states of the plurality of continuous games become the SCG states, resulting in an occurrence of a pseudo high probability CG state.

However, a continuation condition of the pseudo high probability CG state is that the SCT is selected as the winning combination for reel-stop, and the pseudo high probability CG state is ended at the game in which all the small combinations are selected as the winning combination for reel-stop. Hence, such a control is performed, in which the number of sliding symbols (the maximum number of sliding symbols) becomes “0” unless the Replay is set as the winning combination for reel-stop in the pseudo high probability CG state period. Also in the CG state, there is a case where the SCT is internally won, resulting in the occurrence of the pseudo high probability CG state, thereby causing the gaming states of the plurality of continuous games to become the CG states.

When the internally won combination is the Replay, the Replay is selected as the winning combination for reel-stop in the normal gaming state, the carryover state, the CT normal gaming state, the BB normal gaming state, the RB gaming state, and the SB gaming state. Meanwhile, in the CT1-period CG state, the CT2-period CG state, and the SCG state, either the Replay or all the small combinations are selected as the winning combination for reel-stop (a probability of the selection thereof can also be made to differ from one another in each of the states described above).

The probability sortition tables (FIG. 7B and FIG. 8A) for use in the CT1-period CG state, the CT2-period CG state, and the SCG state period are configures so that the probability to internally win the Replay can become the highest. When the Replay is internally won, the winning combinations for reel-stop are distributed to the Replay or all the small combinations.

When the internally won combination is the small combination of the watermelon, the small combination of the watermelon is selected as the winning combination for reel-stop in the normal gaming state, the carryover state, the CT normal gaming state, and the BB normal gaming state. Meanwhile, in the CT1-period CG state, the CT2-period CG state, and the SCG state, all the small combinations are selected as the winning combination for reel-stop.

When the internally won combination is the small combination of the bell, the small combination of the bell is selected as the winning combination for reel-stop in the normal gaming state, the carryover state, the CT normal gaming state, and the BB normal gaming state. Meanwhile, in the CT1-period CG state, the CT2-period CG state, and the SCG state, all the small combinations are selected as the winning combination for reel-stop.

When the internally won combination is the group combination, any of the small combination of the upper cherry, the small combination of the lower cherry, and the small combination of the large cherry (the small combination of the upper cherry and the small combination of the lower cherry) is selected as the winning combination for reel-stop in the normal gaming state, the carryover state, the CT normal gaming state, and the BB normal gaming state. A probability to select the small combination of the large cherry as the winning combination for reel-stop is the highest.

Moreover, when the internally won combination is the group combination, any of the small combination of the upper cherry, the small combination of the lower cherry, the small combination of the large cherry, and all the small combinations is selected as the winning combination for reel-stop in the CT1-period CG state and the CT2-period CG state. In the CT1-period CG state, a probability to select the small combination of the large cherry (in which the payout number is “15”) as the winning combination for reel-stop is the highest. In the CT2-period CG state, a probability to select the small combination of the upper cherry (in which the payout number is “2”) as the winning combination for reel-stop is the highest (probabilities to select the respective combinations as the winning combination for reel-stop differ from one another).

The ending condition of the CT gaming state includes that the earned number becomes a predetermined number or more. Hence, an expectation value of the number of continuous games in the CG gaming state which occurs on an occasion that the CT distributed to the CT1 is won becomes larger than an expectation value of the number of continuous games in the CT gaming state which occurs on an occasion that the CT distributed to the CT2 is won. A configuration is adopted, in which it is made possible to generate the plurality of CT gaming states in which the expectation values of the numbers of continuous games are different from one another, thereby causing a case where a variety of gaming characteristics can be realized.

Moreover, when the internally won combination is the group combination, all the small combinations are selected as the winning combination for reel-stop in the SCG state.

When the internally won combination is the small combination of the JAC, the small combination of the JAC is selected as the winning combination for reel-stop in the RB gaming state and the SB gaming state.

When the internally won combination is the “none (losing)”, the “none (losing)” is selected as the winning combination for reel-stop in the normal gaming state, the Cr normal gaming state, the BB normal gaming state, the RB gaming state, and the SB gaming state.

Moreover, when the internally won combination is the “none (losing)”, the carryover combination is selected as the winning combination for reel-stop in the carryover state. The carryover combination includes the RB carried over in the BB-period RB carryover state. In the CT1-period CG state, the CT2-period CG state, and the SCG state, all the small combinations are selected as the winning combination for reel-stop.

The winning combination tables for stop are provided for each of the setting values; however, the winning combination tables for each of the setting values are omitted. In this embodiment, the selection probability of the winning combination for stop, which corresponds to at least any of the internally won combinations, is made to differ between at least any pair of the “two” setting values. Moreover, the internally won combination can be decided by using one winning combination table for stop for all the setting values, and the probability sortition tables for use in deciding the winning combination for reel-stop, which is to be described later, can be made to differ from one another in response to the settings.

FIG. 11 shows a circuit configuration including a main control circuit 71 which controls gaming process operations in the gaming machine 1, peripheral devices (actuators) electrically connected to the main control circuit 71, and a sub-control circuit 72 which controls the liquid crystal display device 5 and the speakers 21L and 21R based on control instructions transmitted from the main control circuit 71.

The main control circuit 71 includes, as a main constituent, a microcomputer 30 disposed on a circuit board, and additionally, a circuit for random number sampling. The microcomputer 30 includes a CPU 31 which performs control operations according to a preset program, and a ROM 32 and a RAM 33 as storing means.

To the CPU 31, there are connected a clock pulse generator circuit 34 and a frequency divider 35 which generate a reference clock pulse, and a random number generator 36 and a sampling circuit 37 which generate the random number to be sampled. Note that, as means for the random number sampling, a configuration may also be adopted, in which the random number sampling is executed in the microcomputer 30, that is, on the operation program of the CPU 31. In this case, it is possible to omit the random number generator 36 and the sampling circuit 37, or alternatively, it is possible to leave the random number generator 36 and the sampling circuit 37 for backup of the random number sampling operation.

In the ROM 30 of the microcomputer 30, there are stored the probability sortition tables (FIG. 7A to FIG. 9C) for use in determining the random number sampling performed for each of the operations of the start lever 6 (starting operations), a stop table group for deciding the stop mode of the reels in response to the operation of the stop button, various control instructions (commands) for transmitting the stop mode to the sub-control circuit 72, and the like. The sub-control circuit 72 does not input the command, information, and the like to the main control circuit 71, and a communication is performed in only one direction from the main control circuit 71 to the sub-control circuit 72. In the RAM 33, various pieces of information are stored. For example, flags, information regarding the gaming state, and the like are stored.

In the circuit of FIG. 11, as main actuators of which operations are controlled by control signals from the microcomputer 30, there are mentioned the BET lamps (the 1-BET lamp 9a, the 2-BET lamp 9b, the maximum BET lamp 9c), the information display portion 18, the BB-period payable number displays 23L, 23C and 23R, a hopper 40 which houses the medals therein and pays out a predetermined number of medals according to a command of a hopper driving circuit 41 (the hopper 40 including a drive portion for the payout), and stepping motors 49L, 49C and 49R which rotationally drive the reels 3L, 3C and 3R.

Moreover, to an output portion of the CPU 31, there are connected a motor driving circuit 39 which performs a control to drive the stepping motors 49L, 49C and 49R, the hopper driving circuit 41 which performs a control to drive the hopper 40, a lamp driving circuit 45 which performs a control to drive the BET lamps 9a, 9b and 9c, a 7-segment LED driving circuit 47 which performs a control to drive the BB-period payable number displays 23L, 23C and 23R, and a display portion driving circuit 48 which performs a control to drive the information display portion 18. These driving circuits individually receive control signals such as drive instructions outputted from the CPU 31, and control the operations of the respective actuators.

Furthermore, as main input signal generating means for generating input signals necessary for the microcomputer 30 to generate the control instructions, there are mentioned a start switch 6S, the 1-BET switch 11, the 2-BET switch 12, the maximum-BET switch 13, the C/P switch 14, a medal sensor 22S, a reel stop signal circuit 46, a reel position detection circuit 50, and a payout completion signal circuit 51.

The start switch 6S detects the operation of the start lever 6. The medal sensor 22S detects the medals dropped into the medal insertion slit 22. The reel stop signal circuit 46 generates stop instruction signals in response to the operations of the respective stop buttons 7L, 7C and 7R. The reel position detection circuit 50 receives pulse signals from reel rotation sensors, and supplies signals for detecting the positions of the respective reels 3L, 3C and 3R to the CPU 31. The payout completion signal circuit 51 generates a signal for sensing the completion of the medal payout when a counted value (the number of medals paid out from the hopper 40) of a medal detection unit 40S reaches designated data of the number.

In the circuit of FIG. 11, the random number generator 36 generates random numbers belonging to a fixed numeric value range, and the sampling circuit 37 samples one random number at appropriate timing after the start lever 6 is operated. The winning combination is decided based on the random number thus sampled and the probability sortition table stored in the ROM 32.

After the rotations of the reels 3L, 3C and 3R are rotated, the number of drive pulse supplied to the respective stepping motors 49L, 49C and 49R is counted, and the counted values thereof are written into a predetermined area of the RAM 33. Reset pulses are obtained from the reels 3L, 3C and 3R at each rotation thereof, and these pulses are inputted to the CPU 31 through the reel position detection circuit 50. By the reset pulses thus obtained, the counted values of the drive pulses counted in the RAM 33 are cleared to “0”. Thus, in the RAM 33, counted values, each of which corresponds to a rotation position within a one-rotation range for each of the reels 3L, 3C and 3R, are stored.

In order to associate the rotation positions of the reels 3L, 3C and 3R, which are as described above, and the symbols drawn on the outer circumferential surfaces of the reels with each other, a symbol table (not shown) is stored in the ROM 32. In the symbol table, code numbers sequentially given to the respective fixed rotation pitches of the reels 3L, 3C and 3R and symbol codes showing the symbols, which are provided so as to correspond to the respective code numbers, are associated with each other while taking the rotation positions where the above-described reset pulses are generated as references.

Moreover, a winning symbol combination table (not shown) is stored in the RCM 32. In the winning symbol combination table, the combinations of the symbols which bring the winning, the payout numbers of medals for the winning, and winning determination codes which represent the winning are associated with one another. The above-described winning symbol combination table is referred to at the time when the left reel 3L, the center reel 3C, and the right reel 3R are controlled to be stopped and in the case where the winning is verified after all the reels 3L, 3C and 3R are stopped.

Based on a sortition process (a probability sortition process) based on the above-described random number sampling, the CPU 31 sends a signal for performing the control to stop the reels 3L, 3C and 3R based on operation signals from the reel stop signal circuit 46 at the timing when the player operates the stop buttons 7L, 7C and 7R and based on the selected “stop table”.

When the stop mode which represents the wing of the won combination comes, the CPU 31 supplies a payout instruction signal to the hopper driving circuit 41, and pays out the predetermined number of medals from the hopper 40. At this time, the medal detection unit 40S counts the number of medals paid out from the hopper 40, and the medal payout completion signal is inputted to the CPU 31 when the counted value reaches the designated number. Thus, the CPU 31 stops the drive of the hopper 40 through the hopper driving circuit 41, and ends a “medal payout process”.

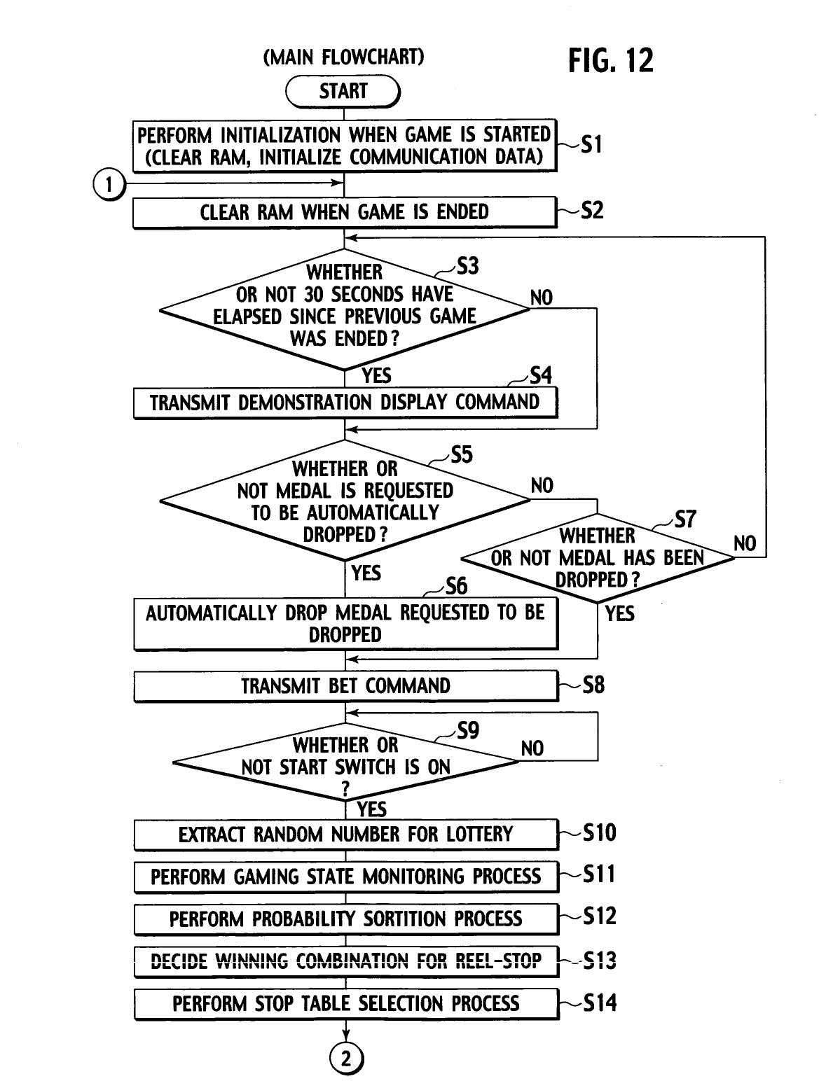

A description will be made of the control operation of the main control circuit 71 with reference to main flowcharts shown in FIG. 12 to FIG. 14.

First, the CPU 31 performs initialization at the time when the game is started (Step S1). Specifically, the contents stored in the RAM 33, the communication data, and the like are initialized. Subsequently, a predetermined content stored in the RAM 33 at the time when the game is ended (which is information in a predetermined storage area (for example, an area where the internally won combination is stored)) is deleted (Step S2). Specifically, the data in the writable area of the RAM 33, which was used in the previous game, is deleted, a parameter necessary for the next game is written into the write area of the RAM 33, a start address of a sequence program of the next game is indicated, and so on. Next, it is determined whether or not “30” seconds have elapsed since the end of the previous game, that is, since the stop of all the reels 3L, 3C and 3R (Step S3). If a result of the determination is “YES”, then a “demonstration display command” which requests the sub-control circuit 72 to display a “demonstration image” is transmitted to the sub-control circuit 72 (Step S4). If the result of the determination in Step S3 is “NO”, the operation proceeds to Step S5.

Next, the CPU 31 determines whether or not the medal is requested to be automatically dropped, that is, the winning of the Replay was realized in the previous game (Step S5). If a result of the determination is “YES”, then the medal requested to be dropped is automatically dropped (Step S6), and the operation proceeds to Step S8. If the result of the determination in Step S5 is “NO”, then it is determined whether or not there is an input from the medal sensor 22S or the BET switches 11 to 13 (Step S7). If a result of the determination is “YES”, then the operation proceeds to Step S8, and if the result of the determination is “NO”, then the operation proceeds to Step S3.

In Step S8, a “BET command” which represents that the BET switches 11 to 13 have been operated or that the medal has been dropped is transmitted to the sub-control circuit 72. Subsequently, it is determined whether or not there is an input from the start switch 6S, which is based on the operation of the start lever 6 (Step S9). If a result of the determination is “YES”, then the operation proceeds to Step S10, and if the result of the determination is “NO”, Step S9 is repeated. In Step S10, the random number for the lottery is extracted. The random number extracted by this process is used in the probability sortition process to be described later. Subsequently, a gaming state monitoring process is performed (Step S11).

Next, the CPU 31 performs the probability sortition process (Step S12). In the probability sortition process, the probability sortition tables shown in FIG. 7A to FIG. 9C are used, and the internally won combination is decided in response to the random number extracted in the process of Step S10 and to the gaming state. Moreover, in the probability sortition process, when the RB or the SB is internally won in the CT gaming state, the gaming state is transferred to the carryover state (RB carryover state). Furthermore, when the internally won combination is the CT, the CT is distributed to the CT1 or the CT2 based on the information regarding the lottery and the game, the gaming operation of the player, and the like.

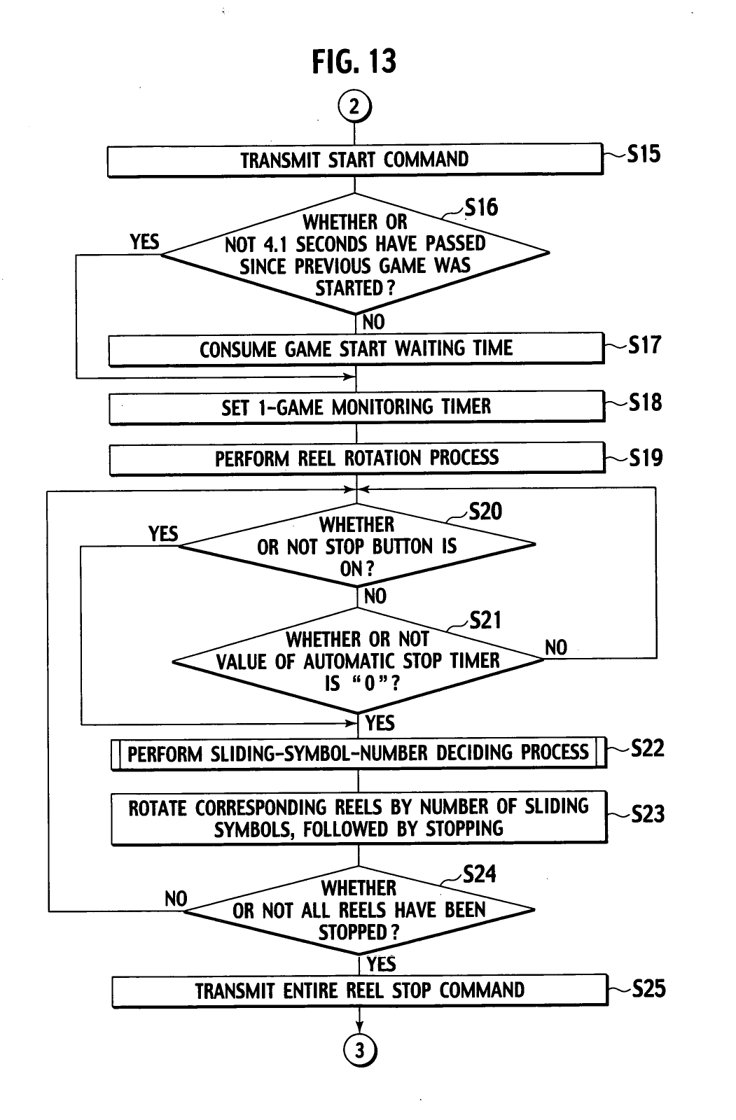

Next, a deciding process of the winning combination for reel-stop is performed (Step S13). In the deciding process of the winning combination for reel-stop, the winning combination table for stop, which is shown in FIG. 10, is used, and the winning combination for reel stop is deiced in response to the internally won combination decided in Step S12 and to the gaming state. Moreover, the payline (a table line) in which the symbol combination corresponding to the winning combination for reel-stop is arrayed is selected. Subsequently, a stop table selection process is performed (Step S14), and the operation proceeds to Step S15 of FIG. 13.

In Step S15 of FIG. 13, a “start command” is transmitted to the sub-control circuit 72. The “start command” includes the information regarding the internally won combination, the winning combination for reel-stop, the gaming state, and the like. Subsequently, it is determined whether or not “4.1 seconds” have elapsed since the start of the previous game (Step S16). If a result of the determination is “YES”, then the operation proceeds to Step S18, and if the result of the determination is “NO”, then the operation proceeds to Step S17. In Step S17, a process of consuming a game start waiting time is performed, and the operation proceeds to Step S18. Specifically, in Step S17, a process of invalidating the input based on the operation to start the game by the player for a period until the elapse of a predetermined time (for example, predetermined seconds (“4.1 seconds” and the like)) since the start of the previous game is performed.

In Step S18, the CPU 31 sets a 1-game monitoring timer. The 1-game monitoring timer of the process in Step S18 includes an automatic stop timer for automatically stopping the reels 3L, 3C and 3R without depending on the stopping operation of the stop buttons 7L, 7C and 7R by the player. Subsequently, a process of rotating the reels 3L, 3C and 3R is performed (Step S19), and the operation proceeds to Step S20.

In Step S20, the CPU 31 determines whether or not the stop button is “ON”. Specifically, the CPU 31 determines whether or not any of the stop buttons 7L, 7C and 7R has been operated. If a result of the determination is “YES”, then the operation proceeds to Step S22, and if the result of the determination is “NO”, the operation proceeds to Step S21. In Step S21, it is determined whether or not a value of the automatic stop timer is “0”. If a result of the determination is “YES”, the operation proceeds to Step S22, and if the result of the determination is “NO”, the operation returns to Step S20.

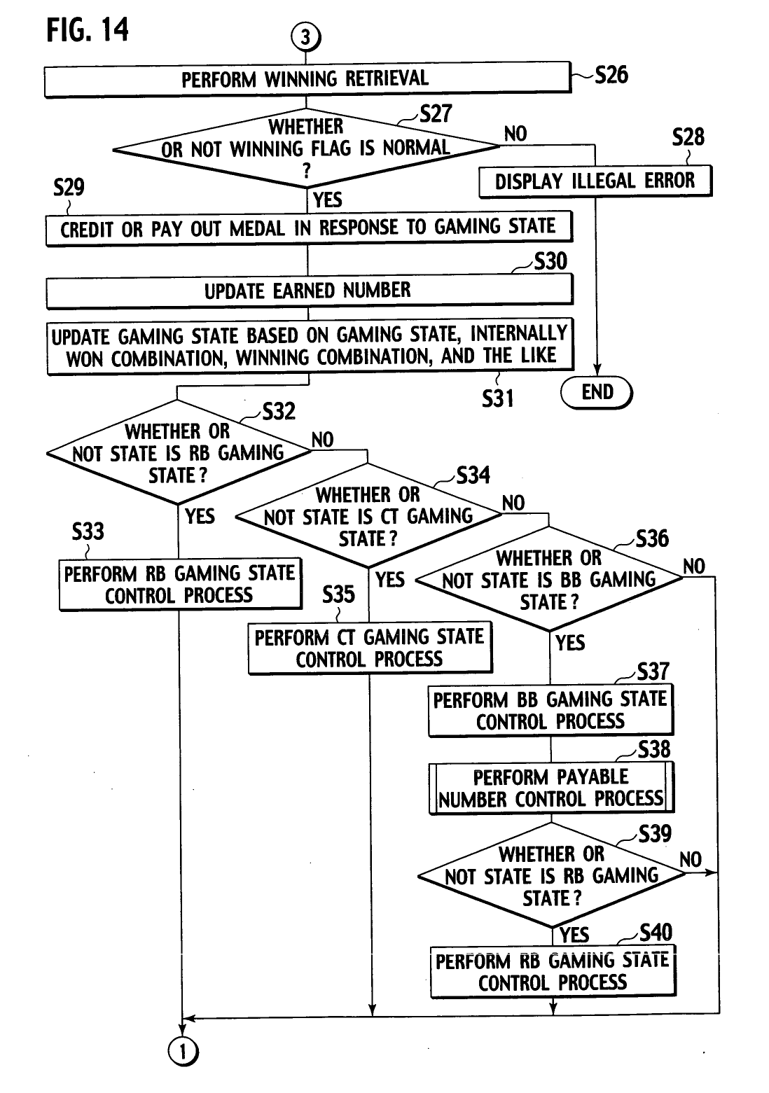

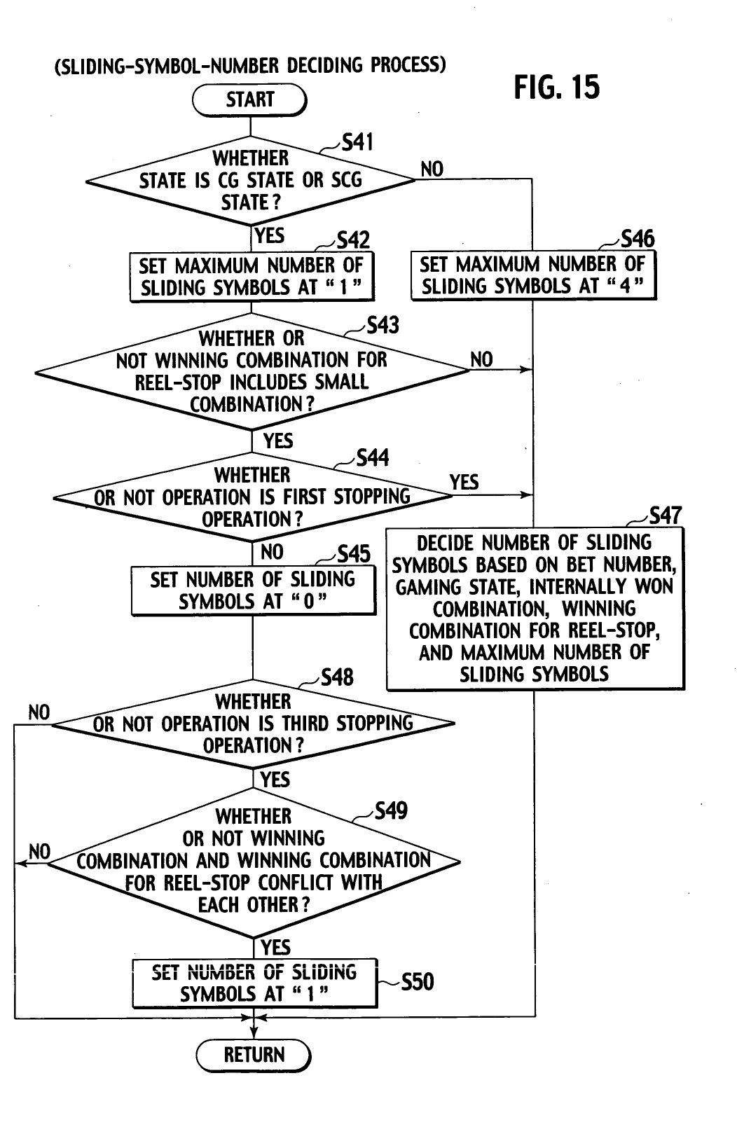

In Step S22, the CPU 31 performs a sliding-symbol-number deciding process to be described later with reference to FIG. 15. Subsequently, the CPU 31 rotates the reels 3L, 3C and 3R corresponding to the stopped stop buttons 7L, 7C and 7R by the number of sliding symbols, which has been decided in Step S22, followed by the stopping of the reel concerned (Step S23). Subsequently, it is determined whether or not all the reels have been stopped (Step S24). If a result of the determination is “YES”, then the operation proceeds to Step S25, and if the result of the determination is “NO”, then the operation proceeds to Step S20. In Step S25, an “entire reel stop command” which represents that all the reels have been stopped is transmitted to the sub-control circuit 72, and the operation proceeds to Step S26 of FIG. 14.

In Step S26 of FIG. 14, the CPU 31 performs winning retrieval. The winning retrieval is to set a winning flag for identifying the winning combination (the won combination) based on the stop modes of the symbols on the display windows 4L, 4C and 4R. Specifically, the CPU 31 identifies the winning combination based on the code numbers of the symbols arrayed along the center line 8c and the winning determination table. Subsequently, it is determined whether or not the winning flag is normal (Step S27). Specifically, when the winning combination is the “losing (none)”, it is determined (judged) that the winning flag is “normal (“YES”)” irrespective of the gaming state. When the winning combination is included in the internal winning combination for determination, it is determined that the winning flag is “normal (“YES”)” irrespective of the gaming state.

Meanwhile, in the case where the winning combination is not included in the internal winning combination for determination, when the gaming state is the other one than the CG state and the SCG state, it is determined that the winning flag is “abnormal (“NO”)”. In the case where the winning combination is not included in the internal winning combination for determination, when the gaming state is the CG state or the SCG state, it is determined that the winning flag is “abnormal (“NO”)” when the winning combination is the bonus (the BB, the CT, the SCT, the RB, the SB, and the like) or the Replay. In the case where the winning combination is not included in the internal winning combination for determination, when the gaming state is the CG state or the SCG state, it is determined that the winning flag is “normal (“YES”)” when the winning combination is the other one than the bonus (the BB, the CT, the SCT, the RB, the SB, and the like) and the Replay.

The internal winning combination for determination (a conditional device under operation) in the process of Step S27 is composed of the internally won combination obtained as a result of the probability sortition process (Step S12 of FIG. 12), and the carryover combination obtained as result of updating the gaming state (Step S31 of FIG. 14, which is to be described later) based on the gaming state, the internally won combination, the winning combination, and the like.

For example, in the case where the small combination of the bell is selected as the internally won combination in the probability sortition process (Step S12 of FIG. 12) in a unit game of the BB carryover state (in which the carryover combination is the BB), the internal winning combination for determination in the game becomes the BB and the small combination of the bell. Further, in the case where the small combination of the watermelon is selected as the internally won combination in the probability sortition process in a unit game of the normal gaming state, the internal winning combination for determination in the game becomes the small combination of the watermelon. It is defined that the winning combination for reel-stop, which is obtained as a result of deciding the winning combination for reel-stop (Step S13 of FIG. 12), is not included in the internal winning combination for determination.

If a result of the determination in Step S27 is “NO”, an illegal error is displayed (Step S28). In this case, the game is discontinued (Step S28). If the result of the determination in Step S27 is “YES”, the medals are credited or paid out in response to the winning combination and the gaming state (Step S29). Subsequently, the earned number is updated (Step S30). In step S30, for example, the information (information stored in the RAM 33) regarding the total payout number of medals (information regarding the accumulated value) up to now in the BB gaming state is updated (the information regarding the accumulated value is updated) based on the payout number of medals in the game of this time.

Next, the CPU 31 updates the gaming state based on the gaming state, the internally won combination, the winning combination, and the like (Step S31). Specifically, when the BB, the CT, or the RB is internally won, the gaming state is updated (transferred) to the carryover state, and any of the BB, the CT, or the BB, which corresponds to the carryover state, is set as the carryover combination. Moreover, the gaming state is updated to the first BB gaming state when the BB without the CT lottery is won, to the second BB gaming state when the BB with the CT lottery is won, to the CT gaming state when the CT is won, and to the RB gaming state when the RB is won. Furthermore, the gaming state is updated to the SCG state when the SCT is won, and to the SB gaming state when the SB is won. When the bonus combination (the BB, the CT, the RB, or the like) is won, the carryover combination is cleared (deleted). Moreover, the gaming state is updated from the SB gaming state or the SCG state to the normal gaming state and the like. Furthermore, when the winning combination is the Replay, information indicating that the winning combination is the Replay is stored. Based on the information, it is determined whether or not the medal is to be automatically dropped when the next game is started (Step S5 of FIG. 12). Note that, when the determination of Step S5 is performed, the information indicating that the winning combination is the Replay is cleared.

Next, the CPU 31 determines whether or not the current gaming state is the RB gaming state which has occurred in the normal gaming state (Step S32). If a result of the determination is “YES”, then the operation proceeds to Step S33, and if the result is “NO”, then the operation proceeds to Step S34.

In Step S33, an RB gaming state control process is performed, and the operation returns to Step S2 of FIG. 12. In the RB gaming state control process of Step S33, the information regarding the number (number of games, number of winnings) is updated, it is decided based on the information regarding the number whether the RB gaming state is to be maintained or to be transferred to the normal gaming state, and so on.

If a result of the determination in Step S32 is “NO”, it is determined whether or not the current gaming state is the CT gaming state (Step S34). If a result of the determination is “YES”, then the operation proceeds to Step S35, and if the result is “NO”, then the operation proceeds to Step S36.

In Step S35, a CT gaming state control process is performed, and the operation returns to Step S2 of FIG. 12. In the CT gaming state control process in Step S35, the information regarding the earned number is updated, the gaming state is transferred (switched) between the CT normal gaming state and the CG state, it is decided based on the earned number whether or not the gaming state is to be transferred to the normal gaming state, and so on.

If a result of the determination in Step S34 is “NO”, then it is determined whether or not the current gaming state is the BB gaming state (Step S36). If a result of the determination is “YES”, then the operation proceeds to Step S37, and if the result is “NO”, then the operation proceeds to Step 2 in FIG. 12.

In Step S37, a BB gaming state control process is performed, and the operation proceeds to Step S38. In the BB gaming state control process in Step S37, the information regarding the earned number is updated, the gaming state is transferred from the BB normal gaming state to the RB gaming state, it is decided based on the earned number whether or not the gaming state is to be transferred to the normal gaming state (the decision is made by determining whether or not the accumulated value of the number of medals given to the player is 465 or more).

Specifically, when the net increase number has reached “465 or more” in the first BB gaming state, or when the “third” RB gaming state is ended, the gaming state is transferred to the normal gaming state. Moreover, when the net increase number has reached “241 or more” in the second BB gaming state, or when the “second” RB gaming state is ended, a lottery is drawn as to whether or not the gaming state is to be transferred to the CT gaming state. When the lottery is won, the gaming state is transferred to the CT gaming state, and when the lottery is not won, the gaming state is transferred to the normal gaming state.

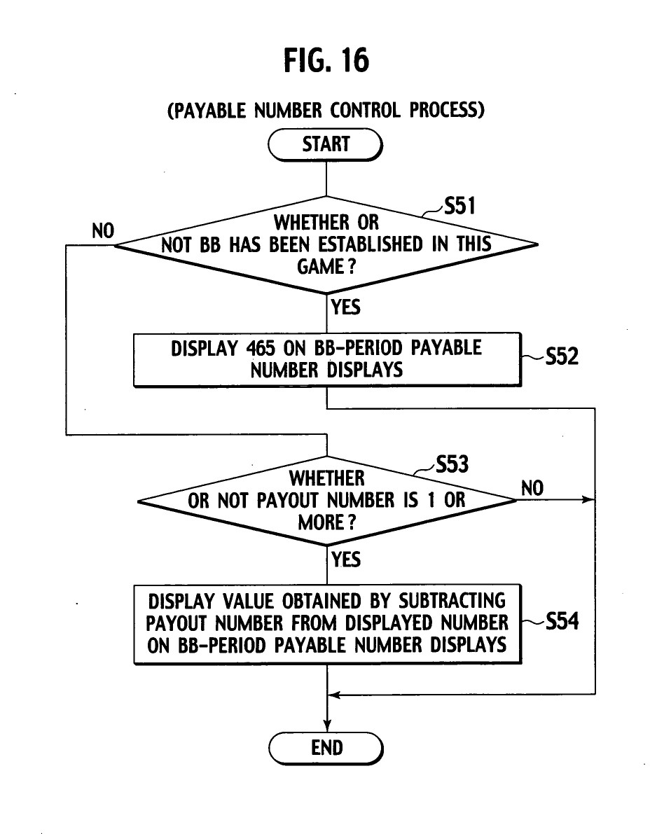

Next, in Step S38, a payable number control process to be described later with reference to FIG. 16 is performed, and the operation proceeds to Step S39. In Step S39, it is determined whether or not the gaming state is the RB gaming state. If a result of the determination is “YES”, then the operation proceeds to Step S40, and if the result is “NO”, then the operation returns to Step S2 of FIG. 12.

In Step S40, an RB gaming state control process is performed, and the operation returns to Step S2 of FIG. 12. In the RB gaming state control process of Step S40, the information regarding the number (number of games, number of winnings) is updated, it is decided based on the information regarding the number whether the RB gaming state is to be maintained or to be transferred to the BB normal gaming state, and so on.

Next, a description will be made of the sliding-symbol-number deciding process performed in Step S22 of FIG. 13 with reference to FIG. 15.

First, the CPU 31 determines whether or not the current gaming state is the CG state or the SCG state (Step S41). If a result of the determination is “YES”, then the process proceeds to Step S42, and if the result is “NO”, the process proceeds to Step S46. In Step S42, the maximum number of sliding symbols is set at “1”, and the process proceeds to Step S43. In Step S43, it is determined whether or not the winning combination for reel-stop includes the small combination. If a result of the determination is “YES”, then the process proceeds to Step S44, and if the result is “NO”, the process proceeds to Step S47.

In Step S44, it is determined whether or not the stop control for the reels at this time corresponds to the first stopping operation. If a result of the determination is “YES”, the process proceeds to Step S47, and if the result is “NO”, the process proceeds to Step S45. In Step S45, when the winning combination for reel-stop is all the small combinations in the CG state or the SCG state, and the stop control for the reels corresponds to the second stopping operation or the third stopping operation, the number of sliding symbols is set at “0”, and the process proceeds to Step S48. When “0” is applied as the number of sliding symbols in the CG state and the SCG state, processes in Step S48 to Step S50 can be omitted.

If the result of the determination in Step S41 is “NO”, that is, if the gaming state is other than the CG state and the SCG state, then the maximum number of sliding symbols is set at “4” (Step S46), and the process proceeds to Step S47. In Step S47, the number of sliding symbols is decided based on the BET number, the gaming state, the internally won combination, the winning combination for reel-stop, the maximum number of sliding symbols, and the like, and the process proceeds to Step S23 of FIG. 13.

In the case where Step S47 is performed when the result of the determination in Step S43 is “NO”, a pulling control for the symbol combinations corresponding to the combinations other than the small combinations (a control for realizing the maximum winning) is performed within a range where the maximum number of sliding symbols is “1” in all the stop controls for the reels, which correspond to the first to third stopping operations. Moreover, in the determination of Step S43, it may also be determined whether or not the winning combination for reel-stop includes the small combinations other than the small combination of the JAC.

Moreover, in the case where Step S47 is performed when the result of the determination in Step S44 is “YES”, the winning combination for reel-stop is all the combinations, and the stop control is performed within the range where the maximum number of sliding symbols is “1” only for the stop control for the reels, which corresponds to the first stopping operation. Note that which combination is to be selected as the combination of the symbols to which priority is given can also be decided by the lottery and the like.

In Step S48, the CPU 31 determines whether or not the stop control for the reels at this time corresponds to the third stopping operation. If a result of the determination is “YES”, then the process proceeds to Step S49, and if the result is “NO”, the process proceeds to Step S23 of FIG. 13. In Step S49, it is determined whether or not the winning combination (the won combination) and the winning combination for reel-stop conflict with each other. If a result of the determination is “YES”, then the process proceeds to Step S50, and if the result is “NO”, then the process proceeds to Step S23. In Step S50, in order to avoid erroneous winning of the Replay, the number of sliding symbols is set at “1”, and the process proceeds to Step S23 of FIG. 13.

Next, a description will be made of the payable number control process performed in Step S38 of FIG. 14 with reference to FIG. 16.

First, the CPU 31 determines whether or not the BB has been established (the symbol combination corresponding to the BB has been arrayed) at this game (Step S51). If a result of the determination is “YES”, then the process proceeds to Step S52, and if the result is “NO”, then the process proceeds to Step S53. In Step S52, 465 (the initial value) is displayed on the BB-period payable number displays 23L, 23C and 23R, and the process proceeds to Step S39 of FIG. 14.

In Step S53, it is determined whether or not the payout number of medals in this game (this unit game) is 1 or more. If a result of the determination is “YES” (for example, if the small combination is won), then the process proceeds to Step S54, and if the result is “NO” (for example, if the Replay is established), then the process proceeds to Step S39 of FIG. 14. In Step S54, the display on the displays is updated from the number currently displayed to a value obtained by subtracting the payout number of this game from the predetermined number, and the process proceeds to Step S39 of FIG. 14. The information regarding the number currently displayed on the displays (the information regarding the value obtained by subtracting the accumulated value from the predetermined number) is stored in the predetermined area of the RAM 33.

In Step S54, the number obtained by subtracting the total payout number of medals up to now, which is updated in Step S30, from 465 (the predetermined number) may also be displayed on the displays.

The description has been made above of the embodiment; however, the present invention is not limited to this.

In this embodiment, the medals are paid out when the symbol combinations corresponding to the BB, the CT, the RB, and the SCT are statically displayed. However, a configuration may also be adopted, in which only the gaming state is transferred (switched), and the medals are not paid out.

In this embodiment, the rest of the total payout number in the BB gaming state (the ending condition of the BB gaming state) is displayed by the BB-period payable number displays 23L, 23C and 23R controlled by the main control circuit 71. However, in addition to this display, on the liquid crystal display device 5 controlled by the sub-control circuit 72, the number obtained by subtracting the number of medals bet for playing the game by the player from the number of medals paid out to the player in the BB gaming state (that is, a so-called difference number) may also be displayed (the difference number may be displayed). In such a way, the player can grasp the difference number (the earned number) while grasping the ending condition of the BB gaming state.

Moreover, in this embodiment, the rest of the total payout number in the BB gaming state (the ending condition of the BB gaming state) is displayed by the BB-period payable number displays 23L, 23C and 23R controlled by the main control circuit 71. However, in addition to this display, on the liquid crystal display device 5 controlled by the sub-control circuit 72, the information regarding the accumulated value or the information regarding the value obtained by subtracting the accumulated value from the predetermined number may also be displayed. In such a way, the interest of the game can be enhanced by the effect on the liquid crystal display device 5, and in addition, for example, even if a malfunction occurs on the liquid crystal display device 5 owing to an unexpected situation such as a lightning stroke, the ending condition of the BB gaming state can be surely notified to the player.

In this embodiment, the 7-segment LEDs which are visual information transmitting means are employed as the accumulated information display means; however, the accumulated information display means is not limited to the 7-segment LEDs. For example, a liquid crystal display device, and a speaker which is audio information transmitting means, can also be employed. Also in this case, it is preferable that the main control circuit 71 perform the control.

Moreover, predetermined number determining means for determining the total payout number (the predetermined number or the updated value thereof) which is the ending condition of the BB gaming state when the BB is established and determining (changing) the total payout number concerned while the gaming state is being the BB gaming state may also be provided. In such a way, the predetermined number and the like in the BB gaming state become changeable, and accordingly, the variety of the game is increased, thus making it possible to enhance the interest of the game. In addition, even in the gaming machine with such a variety, the player can clearly grasp the ending condition of the BB gaming state, and can enjoy the game with peace of mind.

Furthermore, besides the gaming machine 1 as described in this embodiment, the present invention is also applicable to other gaming machines such as a pachinko gaming machine and a pachi-slot machine. Moreover, also in a game program in which the operation of the above-described gaming machine 1 is executed as for use in a family gaming machine, a game can be executed by applying the present invention thereto. In this case, as a recording medium which records the game program, a CD-ROM, an FD (a floppy disk), and other arbitrary recording mediums are usable.

What is claimed is:

1. A gaming machine, comprising:
a game start instruction unit configured to output a game start instruction signal in response to an operation by a player;
a variation display unit configured to variably display symbols necessary for a game based on the game start instruction signal frcm the game start instruction unit;
an internal winning combination decision unit configured to decide an internal winning combination based on the game start instruction signal from the game start instruction unit;
a stop instruction unit configured to output a stop instruction signal in response to an operation of an operation unit operated by the player;
a stop control unit configured to stop the variation display of the symbols based on the internal winning combination decided by the internal winning combination decision unit when the stop instruction unit outputs the stop instruction signal;
a winning determination unit configured to determine whether or not a combination of the statically displayed symbols is won when the variation display is stopped by the stop control unit;
a game medium payout unit configured to pay out a predetermined number of game medium when it is determined by the winning determination unit that the combination is won;
a special gaming state generation unit configured to generate a special gaming state under a condition where the combination of the statically displayed symbols is a specific symbol combination when the variation display is stopped by the stop control unit;
an accumulated information storage unit configured to store information regarding an accumulated value of the number of game mediums paid out to the player by the game medium payout unit in the special gaming state or information regarding a value obtained by subtracting the accumulated value from a predetermined number;
an accumulated information update unit configured to update the information stored in the accumulated information storage unit based on the number of game medium paid out to the player by the game medium payout unit;
an accumulated value determination unit configured to determine based on the information stored in the accumulated information storage unit whether or not the accumulated value of the number of game medium paid out to the player by the game medium payout unit in the special gaming state is the predetermined number or more;
a special gaming state ending unit configured to end the special gaming state when the accumulated value determination unit determines that the accumulated value is the predetermined number or more; and
an accumulated information display unit configured to display the information stored in the information storage unit.
